(19) United States
(12) Patent Application Publication
(10) Pub. No.: US 2026/0181436 A1
(43) Pub. Date: Jun. 25, 2026

(54) COMMUNICATION CONTROL METHOD AND USER EQUIPMENT

(71) Applicant: KYOCERA Corporation, Kyoto (JP)

(72) Inventor: Mitsutaka HATA, Yokohama-shi (JP)

(73) Assignee: KYOCERA Corporation, Kyoto (JP)

(21) Appl. No.: 19/534,645

(22) Filed: Feb. 9, 2026

Related U.S. Application Data
(63) Continuation of application No. PCT/JP2024/028539, filed on Aug. 8, 2024.

(30) Foreign Application Priority Data
Aug. 9, 2023 (JP) 2023-129737

(51) Int. Cl. H04W 24/08; G06N 20/00; H04W 72/23; H04W 72/51; H04W 88/02; H04W 88/06

(52) U.S. Cl. CPC H04W 24/08; G06N 20/00; H04W 72/23; H04W 72/51; H04W 88/02; H04W 88/06

(57) ABSTRACT

A communication control method according to an aspect is a communication control method in a mobile communication system including a transmission entity configured to infer inference result data from inference data by using a trained AI/ML model and a reception entity, wherein the transmission entity is capable of transmitting the inference result data to the reception entity. The communication control method includes determining, by any of the transmission entity or the reception entity, to start monitoring of the trained AI/ML model, based on training record data obtained by compressing training data used when causing the AI/ML model to undergo model training.

### RELATED APPLICATIONS

The present application is a continuation based on PCT Application No. PCT/JP2024/028539, filed on Aug. 8, 2024, which claims the benefit of Japanese Patent Application No. 2023-129737 filed on Aug. 9, 2023. The content of which is incorporated by reference herein in their entirety.

### TECHNICAL FIELD

The present disclosure relates to a communication control method and a user equipment.

### BACKGROUND

In recent years, in the Third Generation Partnership Project (3GPP), which is a standardization project for mobile communication systems (registered trademark; hereinafter the same), studies have been conducted to apply artificial intelligence (AI) technology, particularly machine learning (ML), technology to wireless communication (air interface) of a mobile communication system.

### CITATION LIST

### Non-Patent Literature

Non-Patent Document 1: 3GPP Contribution RP-213599, “New SI. Study on Artificial Intelligence (AI)/Machine Learning (ML) for NR Air Interface”

### SUMMARY

A communication control method according to a first aspect is a communication control method in a mobile communication system including a transmission entity configured to infer inference result data from inference data by using a trained AI/ML model and a reception entity, in which the transmission entity is capable of transmitting the inference result data to the reception entity. The communication control method includes determining, by any of the transmission entity or the reception entity, to start monitoring of the trained AI/ML model, based on training record data obtained by compressing training data used when causing the AI/ML model to undergo model training.

A communication control method according to a second aspect is a communication control method in a mobile communication system including a transmission entity configured to infer inference result data from inference data by using a trained AI/ML model and a reception entity, in which the transmission entity is capable of transmitting the inference result data to the reception entity. The communication control method includes determining, by the transmission entity, to start monitoring of the trained AI/ML model, based on an inference probability output from the AI/ML model when the inference result data is inferred.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of an LMF according to the first embodiment.

FIG. 5 is a diagram illustrating a configuration example of a protocol stack according to the first embodiment.

FIG. 6 is a diagram illustrating a configuration example of a protocol stack according to the first embodiment.

FIG. 7 is a diagram illustrating a configuration example of functional blocks of an AI/ML technology according to the first embodiment.

FIG. 8 is a diagram illustrating an operation example in the AI/ML technology according to the first embodiment.

FIG. 9 is a diagram illustrating an arrangement example of functional blocks of the AI/ML technology according to the first embodiment.

FIG. 10 is a diagram illustrating an operation example according to the first embodiment.

FIG. 11 is a diagram illustrating an arrangement example of functional blocks of the AI/ML technology according to the first embodiment.

FIG. 12 is a diagram illustrating an arrangement example of functional blocks of the AI/ML technology according to the first embodiment.

FIG. 13 is a diagram illustrating an arrangement example of functional blocks of the AI/ML technology according to the first embodiment.

FIG. 14 is a diagram illustrating an operation example according to the first embodiment.

FIG. 15 is a diagram illustrating an example of a configuration message according to the first embodiment.

FIG. 16 is a diagram illustrating a configuration example of functional blocks of the AI/ML technology according to the first embodiment.

FIG. 17 is a diagram illustrating a configuration example of a mobile communication system according to the first embodiment.

FIG. 18 is a diagram illustrating an operation example according to the first embodiment.

FIG. 19 is a diagram illustrating an operation example according to the first embodiment.

FIG. 20 is a diagram illustrating an operation example according to the first embodiment.

FIG. 21 is a diagram illustrating a first operation example according to the first embodiment.

FIG. 22A and FIG. 22B are diagrams illustrating an operation example of model re-training processing according to the first embodiment.

FIG. 23 is a diagram illustrating an operation example of fallback processing according to the first embodiment.

FIG. 24 is a diagram illustrating an operation example of model use resumption processing according to the first embodiment.

FIG. 25A and FIG. 25B are diagrams illustrating an operation example of model switching processing according to the first embodiment.

FIG. 26 is a diagram illustrating a second operation example according to the first embodiment.

FIG. 27 is a diagram illustrating a second operation example according to the first embodiment.

FIG. 28A is a diagram illustrating an operation example of model re-training processing according to the first embodiment, and FIG. 28B is a diagram illustrating an operation example of fallback processing according to the first embodiment.

FIG. 29 is a diagram illustrating an operation example of model use resumption processing according to the first embodiment.

FIG. 30 is a diagram illustrating a third operation example according to a second embodiment.

FIG. 31 is a diagram illustrating the third operation example according to the second embodiment.

FIG. 32 is a diagram illustrating an operation example of model re-training processing according to the second embodiment.

FIG. 33 is a diagram illustrating an operation example of fallback processing according to the second embodiment.

FIG. 34 is a diagram illustrating an operation example of model use resumption processing according to the second embodiment.

FIG. 35 is a diagram illustrating a fourth operation example according to the second embodiment.

FIG. 36 is a diagram illustrating the fourth operation example according to the second embodiment.

### DESCRIPTION OF EMBODIMENTS

An object of the present disclosure is to perform monitoring at an optimal timing.

### First Embodiment

A mobile communication system according to a first embodiment will be described with reference to the drawings. In the description of the drawings, the same or similar parts are denoted by the same or similar reference signs.

### Configuration of Mobile Communication System

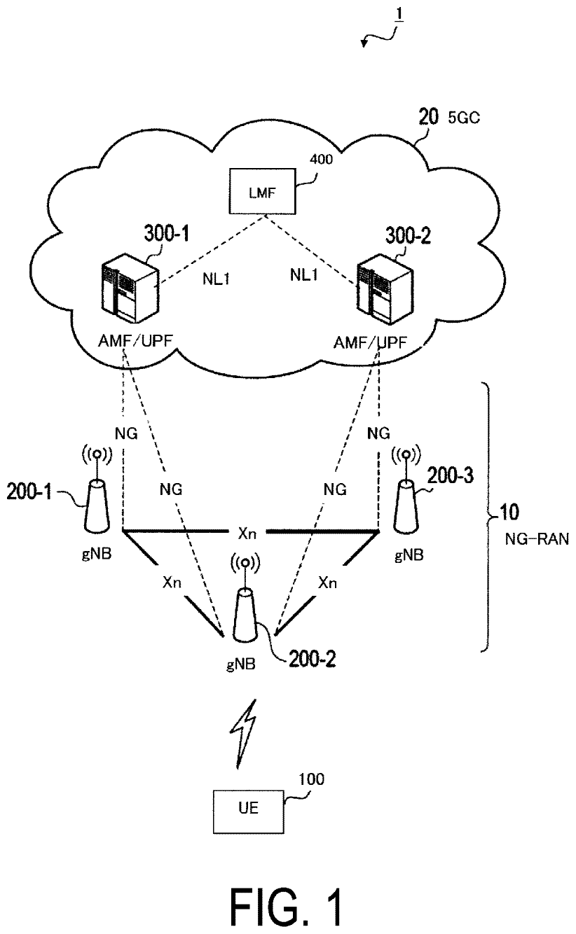

A configuration of a mobile communication system according to a first embodiment will be described. FIG. 1 is a diagram illustrating a configuration example of a mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an access and mobility management function (AMF), a user plane function (UPF) 300, and an LMF 400. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20. The LMF 400 is one of the core network apparatuses that support positioning for the UE 100. The LMF 400 is connected to the AMF via an NL1 interface, which is an interface between the LMF 400 and the AMF. The LMF 400 receives uplink position measurement information from the gNB 200 via the AMF, and receives downlink position measurement information from the UE 100. The LMF 400 can determine a position of the UE 100 based on the position measurement information.

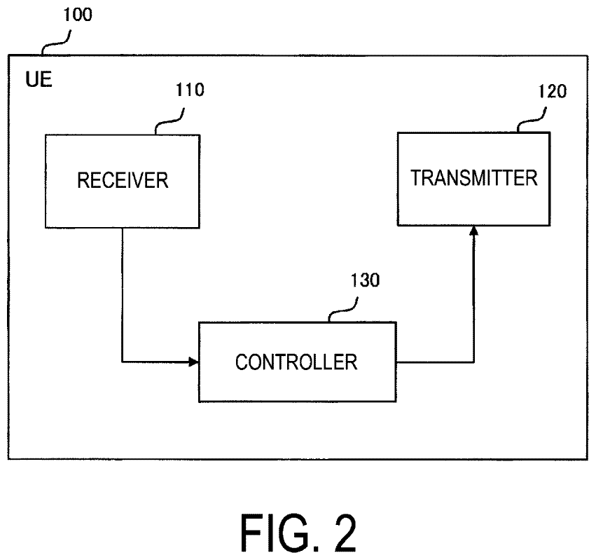

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

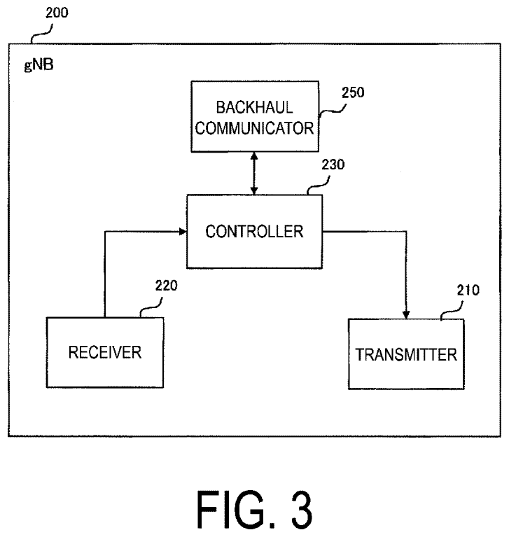

FIG. 3 is a diagram illustrating a configuration example of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

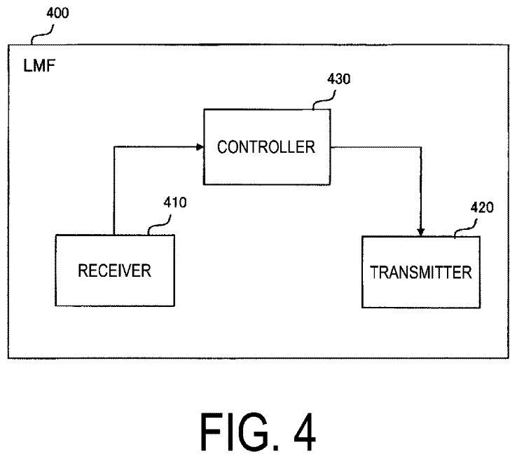

FIG. 4 is a diagram illustrating a configuration example of an LMF 400 according to the first embodiment. The LMF 400 includes a receiver 410, a transmitter 420, and a controller 430.

The receiver 410 performs various types of reception under the control of the controller 430. The receiver 410 receives, via an AMF, an LTE positioning protocol (LPP) message transmitted from the UE 100. Further, the receiver 410 receives, via the AMF, an NR Positioning Protocol A (NRPPa) message transmitted from the gNB 200. The receiver 410 outputs the received messages to the controller 430.

The transmitter 420 performs various types of transmission under the control of the controller 430. The transmitter 420 transmits an LPP message received from the controller 430 to the UE 100 in accordance with an instruction from the controller 430. Further, the transmitter 420 transmits the NRPPa message received from the controller 430 to the gNB 200 in accordance with an instruction from the controller 430.

The controller 430 performs various types of control and processing in the LMF 400.

The controller 430 includes at least one processor and at least one memory. The memory stores programs executed by the processor and information used for processing by the processor. The processor may include a CPU. The CPU executes programs stored in the memory to perform various types of processing. Processing or operations performed by the LMF 400 may be performed by the controller 430.

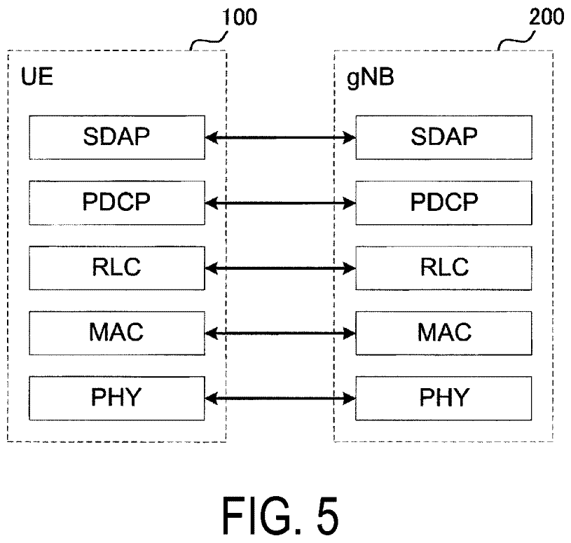

FIG. 5 is a diagram illustrating a configuration example of a protocol stack of a radio interface of a user plane that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. The DCI transmitted from the gNB 200 is appended with Cyclic Redundancy Code (CRC) parity bits scrambled by the RNTI.

In NR, the UE 100 can use a bandwidth narrower than a system bandwidth (i.e., a cell bandwidth). The gNB 200 configures a bandwidth portion (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

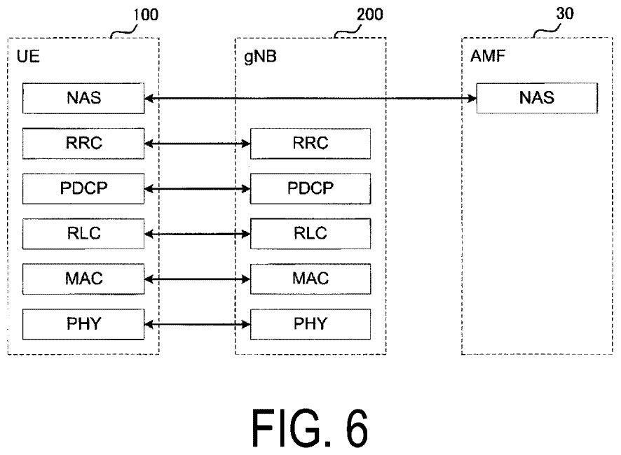

FIG. 6 is a diagram illustrating a configuration of a protocol stack of a wireless interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. The UE 100 includes an application layer other than the protocol of the radio interface. A layer lower than the NAS is referred to as an Access Stratum (AS).

### AI/ML Technology

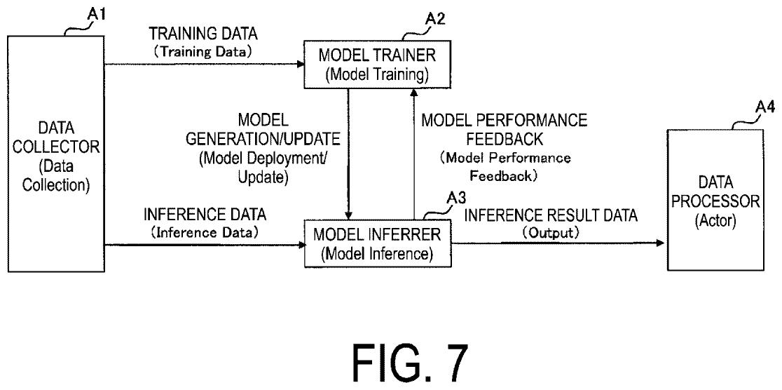

In the embodiment, an AI/ML Technology will be described. FIG. 7 is a diagram illustrating a configuration example of functional blocks of the AI/ML technology in the mobile communication system 1 according to the first embodiment.

The functional block configuration example illustrated in FIG. 7 includes a data collector A1, a model trainer A2, a model inferrer A3, and a data processor A4.

The data collector A1 collects input data, specifically, training data and inference data. The data collector A1 outputs the training data to the model trainer A2. The data collector A1 also outputs the inference data to the model inferrer A3. The data collector A1 may acquire data in the apparatus in which the data collector A1 is provided, as input data. The data collector A1 may acquire, as the input data, data in another apparatus. Data collection refers to the process of collecting data at a network node, a management entity, or the UE 100, for example, to train AI/ML models, perform data analysis, and inference. Based on the data collected by the data collector A1, the training of the AI/ML model and the inference of the AI/ML model in the subsequent stage are performed. The “AI/ML model” is, for example, a data-driven algorithm to which an AI/ML technology is applied to generate a series of outputs based on a series of inputs. Hereinafter, the “model” and the “AI/ML model” may be used interchangeably.

The model trainer A2 performs model training. Specifically, the model trainer A2 optimizes parameters of the trained model through machine learning using the training data, and derives (or generates, or updates) the trained model. The model trainer A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score. Although supervised learning will be described below, unsupervised learning or reinforcement learning may be applied as machine learning. In this way, the process of training an AI/NL model (by training the relationship between input and output) in a data-driven manner and acquiring a trained AI/ML model is called, for example, AI/ML model training. Hereinafter, the “AI/ML model training” may be referred to as a “model training”. The trained AI/ML model may be referred to as a “trained model”.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model trainer A2. This process of using a trained AI/ML model to generate a series of outputs based on a series of inputs is called AI/ML model inference. Hereinafter, the “AI/ML model inference” may be referred to as “model inference”.

The data processor A4 receives the inference result data and performs processing that utilizes the inference result data.

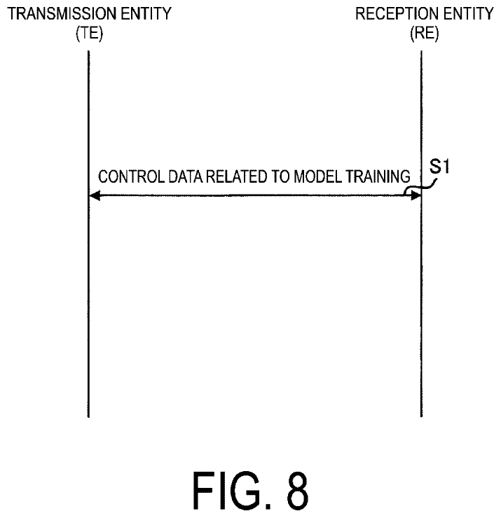

FIG. 8 is a diagram illustrating an operation example in the AI/ML technology according to the first embodiment.

A transmission entity TE is, for example, an entity in which machine learning is performed. The transmission entity TE may derive a trained model by performing machine learning. Then, the transmission entity TE uses the trained model to generate inference result data as an inference result. The transmission entity TE can transmit the inference result data to a reception entity RE.

The reception entity RE is, for example, an entity in which no machine learning is performed. The reception entity RE can receive the inference result data transmitted from the transmission entity TE. The reception entity RE performs various processing operations by using the inference result data. The reception entity RE may derive a trained model by performing machine learning. In this case, the reception entity RE transmits the derived trained model to the transmission entity TE.

The entity may be, for example, a device, may be a functional block included in a device, or may be a hardware block included in a device.

For example, the transmission entity TE may be the UE 100, and the reception entity RE may be the gNB 200 or a core network apparatus. Alternatively, the transmission entity TE may be the gNB 200 or a core network apparatus, and the reception entity RE may be the UE 100.

As illustrated in FIG. 8, in step S1, the transmission entity TE transmits control data related to AI/ML technology to the reception entity RE or receives the control data from the reception entity RE. The control data may be an RRC message that is RRC layer (i.e., layer 3) signaling. The control data may be a MAC Control Element (CE) that is MAC layer (i.e., layer 2) signaling. The control data may be Downlink Control Information (DCI) that is PHY layer (i.e., layer 1) signaling. The downlink signaling may be UE-specific signaling. The downlink signaling may be broadcast signaling. The control data may be a control message in a control layer (e.g., an AI/ML layer) dedicated to artificial intelligence or machine learning.

### Arrangement Examples and Use Cases

How functional blocks illustrated in FIG. 7 are arranged in the mobile communication system 1 will be described. Hereinafter, arrangement examples of the functional blocks will be described along specific use cases.

Use cases applied in the AI/ML technology include, for example, the following three cases.
(1.1) “Channel State Information (CSI) feedback enhancement”
(1.2) “Beam management”
(1.3) “Positioning accuracy improvement”
   Hereinafter, an arrangement example of the functional blocks will be described for each use case.

### (1.1) Arrangement Example of Functional Blocks in “CSI Feedback Enhancement”

The “CSI feedback enhancement” represents, for example, a use case where the machine learning technology is applied to the CSI fed back from the UE 100 to the gNB 200. The CSI is information related to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

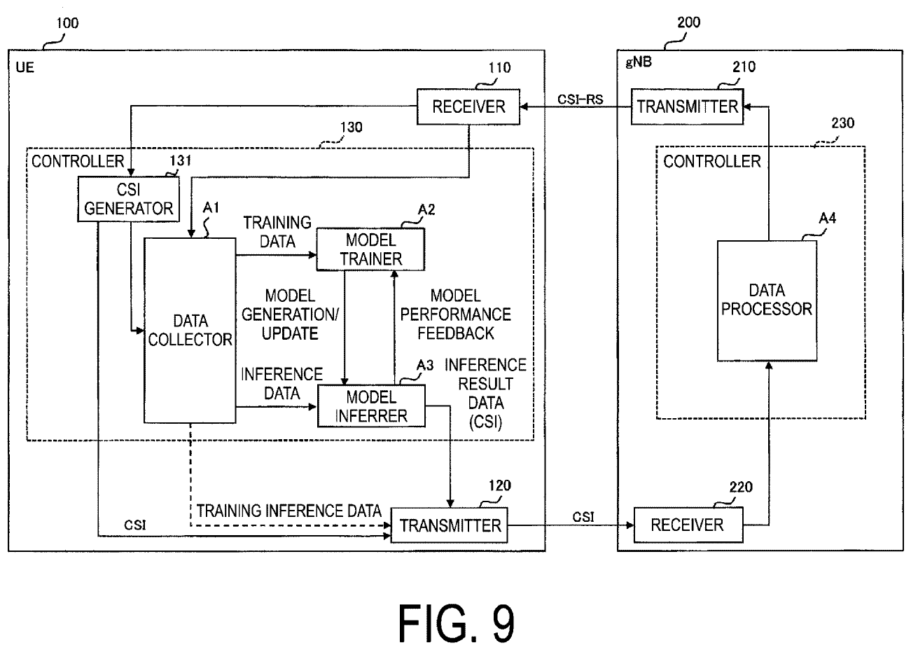

FIG. 9 is a diagram illustrating an arrangement example of the functional blocks in the “CSI feedback enhancement”. In the example of “CSI feedback enhancement” illustrated in FIG. 9, the controller 130 of the UE 100 includes the data collector A1, the model trainer A2, and the model inferrer A3. On the other hand, the controller 230 of the gNB 200 includes the data processor A4. In other words, the UE 100 performs model training and model inference. FIG. 9 illustrates an example in which the transmission entity TE is the UE 100 and the reception entity RE is the gNB 200.

In the “CSI feedback enhancement”, the gNB 200 transmits a reference signal for the UE 100 to estimate the downlink channel state. The reference signal will be described below taking a CSI reference signal (CSI-RS) as an example, but may be a demodulation reference signal (DMRS).

First, in the model training, the UE 100 (receiver 110) receives a first reference signal from the gNB 200 by using first resources. Then, the UE 100 (model trainer A2) derives a trained model for inferring CSI from the reference signal by using training data including the first reference signal. Such a first reference signal may be referred to as a full CSI-RS.

For example, a CSI generator 131 performs channel estimation by using the reception signal (CSI-RS) received by the receiver 110, and generates CSI. The transmitter 120 transmits the generated CSI to the gNB 200. The model trainer A2 performs model training by using a set of the reception signal (CSI-RS) and the CSI as the training data to derive a trained model for inferring the CSI from the reception signal (CSI-RS).

Second, in the model inference, the receiver 110 receives a second reference signal from the gNB 200 by using second resources the amount of which is smaller than that of the first resources. Then, the model inferrer A3 uses the trained model to infer the CSI as inference result data using the second reference signal as inference data. Such a second reference signal may hereinafter be referred to as a partial CSI-RS or a punctured CSI-RS.

For example, the model inferrer A3 causes the partial CSI-RS received by the receiver 110 to be input to the trained model as the inference data, and infers the CSI from the CSI-RS. The transmitter 120 transmits the inferred CSI to the gNB 200.

This enables the UE 100 to feed back (or transmit), to the gNB 200, accurate (complete) CSI from the fewer CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

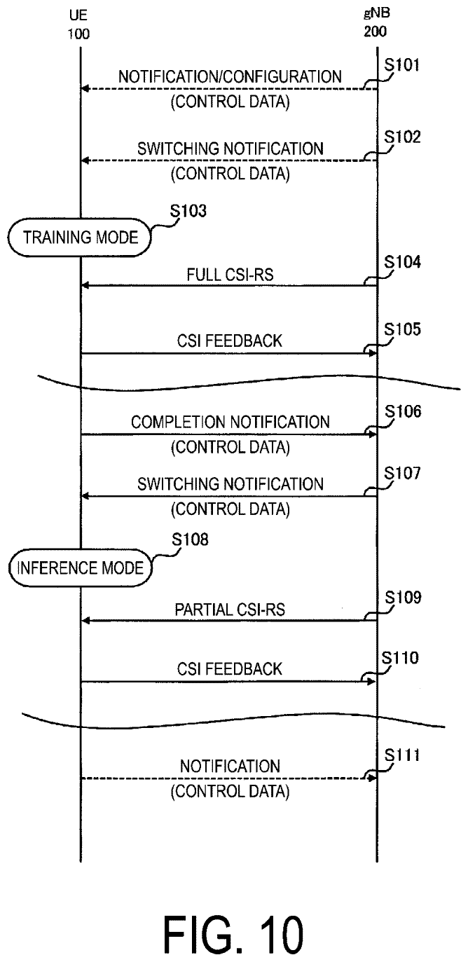

FIG. 10 illustrates an operation example in the “CSI feedback enhancement” according to the first embodiment.

As illustrated in FIG. 10, in step S101, the gNB 200 may notify the UE 100 of or configure for the UE 100, as the control data, a transmission pattern (punctured pattern) of the CSI-RS in the inference mode.

For example, the gNB 200 transmits, to the UE 100, antenna ports and/or time-frequency resources used or not used to transmit the CSI-RS in the inference mode.

In step S102, the gNB 200 may transmit, to the UE 100, a switching notification for causing the UE 100 to start the training mode.

In step S103, the UE 100 starts the training mode.

In step S104, the gNB 200 transmits a full CSI-RS. The receiver 110 of the UE 100 receives the full CSI-RS, and the CSI generator 131 generates (estimates) CSI based on the full CSI-RS. In the training mode, the data collector A1 collects the full CSI-RS and the CSI. The model trainer A2 uses the full CSI-RS and the CSI as training data to generate a trained model.

In step S105, the UE 100 transmits the generated CSI to the gNB 200.

Thereafter, in step S106, when the model training is completed, the UE 100 transmits, to the gNB 200, a completion notification indicating that the model training is completed. The UE 100 may transmit the completion notification when creation of the trained model is completed.

In step S107, in response to receiving the completion notification, the gNB 200 transmits, to the UE 100, a switching notification for switching the UE 100 from the training mode to the inference mode.

In step S108, in response to receiving the switching notification, the UE 100 switches from the training mode to the inference mode.

In step S109, the gNB 200 transmits a partial CSI-RS. The receiver 110 of the UE 100 receives the partial CSI-RS. In the inference mode, the data collector A1 collects the partial CSI-RS. The model inferrer A3 causes the partial CSI-RS to be input to the trained model as inference data, and obtains CSI as an inference result.

In step S110, the UE 100 transmits (or feeds back), to the gNB 200 as inference result data, the CSI, which is an inference result. The UE 100 can generate a trained model with a predetermined accuracy or higher by repeating model training in the training mode. The inference result obtained by using the trained model generated as described above is expected to have a predetermined accuracy or higher.

Note that, in step S111, upon determining that the model training is necessary, the UE 100 may transmit a notification as the control data to the gNB 200, the notification indicating that the model training is necessary.

In the description of the example illustrated in FIG. 10, the training data is “(full) CSI-RS” and “CSI”, and the inference data is “(partial) CSI-RS”. Hereinafter, the training data and/or the inference data may be referred to as a “dataset”.

In the “CSI feedback enhancement”, in addition to the “CSI-RS” and the “CSI”, for example, the following data and/or information may be used as the dataset.
(X1) Reference Signals Received Power (RSRP), Reference Signal Received Quality (RSRQ), Signal-to-interference-plus-noise ratio (SINR), or an output waveform of an AD converter (a measurement target of these data may be the CSI-RS. The measurement target may be other reception signals received from the gNB 200)
(X2) Bit Error Rate (BER) or Block Error Rate (BLER) ((BER (or BLER) may be measured based on CSI-RS with a total number of transmission bits (or a total number of transmission blocks) being known)
(X3) Moving speed of the UE 100 (which may be measured by a speed sensor in the UE 100)
   What is used as a dataset used for machine learning may be configured. For example, the following processing may be performed. In other words, the UE 100 transmits capability information as the control data to the gNB 200, the capability information indicating which type of input data the UE 100 can handle in the machine learning. The capability information may represent, for example, any of the data or information indicated in (X1) to (X3). The capability information may be information in which training data and inference data are separately designated. The gNB 200 transmits, to the UE 100 as the control data, the data type information used as a dataset. The data type information may represent, for example, any one of data or information indicated in (X1) to (X3). As the data type information, data type information used as training data and data type information used as inference data may be separately designated.

### (1.2) Arrangement Example of Functional Blocks in “Beam Management”

An arrangement example of the functional blocks in the “beam management” will be described. The “beam management” represents, for example, a use case where the machine learning technology is used to manage which beam is an optimum beam among the beams transmitted from the gNB 200.

In the “beam management”, the gNB 200 sequentially transmits beams having different directivities. Each beam includes, for example, a reference signal. The UE 100 measures the reception quality of each beam using the reference signal included in the beam. The UE 100 determines, for example, a beam with the best reception quality as the optimum beam.

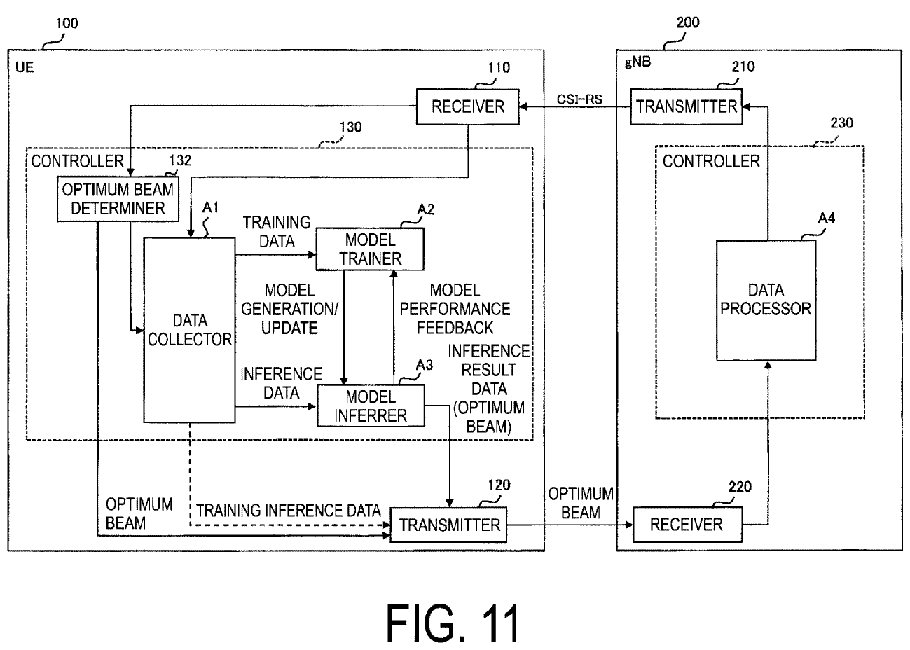

FIG. 11 is a diagram illustrating an arrangement example of the functional blocks in the “beam management”. In the example of the “beam management” illustrated in FIG. 11, the controller 130 of the UE 100 includes the data collector A1, the model trainer A2, and the model inferrer A3. On the other hand, the controller 230 of the gNB 200 includes the data processor A4. In other words, FIG. 11 illustrates an example in which the UE 100 performs model training and model inference. FIG. 11 illustrates the example in which the transmission entity TE is the UE 100 and the reception entity RE is the gNB 200.

As illustrated in FIG. 11, the UE 100 includes an optimum beam determiner 132. The optimum beam determiner 132 determines the optimum beam based on, for example, the reception quality of the reference signal included in each beam. As with “CSI feedback”, an example in which a CSI-RS is used as the reference signal will be described, but a demodulation reference signal (DMRS) may be used as the reference signal. The transmitter 120 transmits information representing the determined optimum beam to the gNB 200 as the “optimum beam”.

An operation example in the “beam management” can be implemented by replacing the “CSI feedback” with the “optimum beam” in FIG. 10.

In the training mode (step S103), the gNB 200 sequentially transmits, to the UE 100, beams having different directivities (step S104). Each beam includes the full CSI-RS. In the training mode, the data collector A1 of the UE 100 collects the full CSI-RS and the optimum beam (information indicating the optimum beam). The model trainer A2 generates a trained model using the CSI-RS and the optimum beam (information indicating the optimum beam) as training data. The full CSI-RS is an example of the first reference signal, and the partial CSI-RS is an example of the second reference signal.

In the inference mode (step S108), the gNB 200 sequentially transmits beams having different directivities. Each beam includes a partial CSI-RS. In the inference mode, the data collector A1 collects the partial CSI-RS. The model inferrer A3 causes the partial CSI-RS to be input to the trained model as inference data, and obtains the optimum beam (information indicating the optimum beam) as an inference result. The UE 100 transmits the inference result (optimum beam) to the gNB 200 as inference result data.

In the “beam management”, in addition to the “CSI-RS” and the “optimum beam”, for example, the following data and/or information may be used as the data used for the dataset.
(Y1) Synchronization Signal Block (SSB) received from the gNB 200
(Y2) RSRP, RSRQ, SINR, or the output waveform of the AD converter (a measurement target thereof may be the CSI-RS. The measurement target may be other reception signals received from the gNB 200)
(Y3) BER or BLER (BER (or BLER) may be measured based on the CSI-RS with the total number of transmission bits (or the total number of transmission blocks) known)
(Y4) Number of beams or a beam pattern
(Y5) Measurement value of a beam (including multiple values)
(Y6) Moving speed of the UE 100 (which may be measured by the speed sensor in the UE 100)
   The UE 100 may transmit capability information as the control data to the gNB 200, the capability information indicating which type of input data the UE 100 can handle in the machine learning. The capability information may include any information or data from among (Y1) to (Y6). Aside from the training data and the inference data, the capability information may include any information or data from among (Y1) to (Y6). The gNB 200 may transmit, to the UE 100 as the control data, the data type information used as a dataset. The data type information may include, for example, any of the data or information indicated in (Y1) to (Y6).

Aside from the training data and the inference data, the data type information may include any information or data from among (Y1) to (Y6).

### (1.3) Arrangement Example of Functional Blocks in “Positioning Accuracy Improvement”

An arrangement example of the functional blocks in the “positioning accuracy improvement” will be described. The “positioning accuracy improvement” represents, for example, a use case where the accuracy of the position information measured by the UE 100 is enhanced using the machine learning technology.

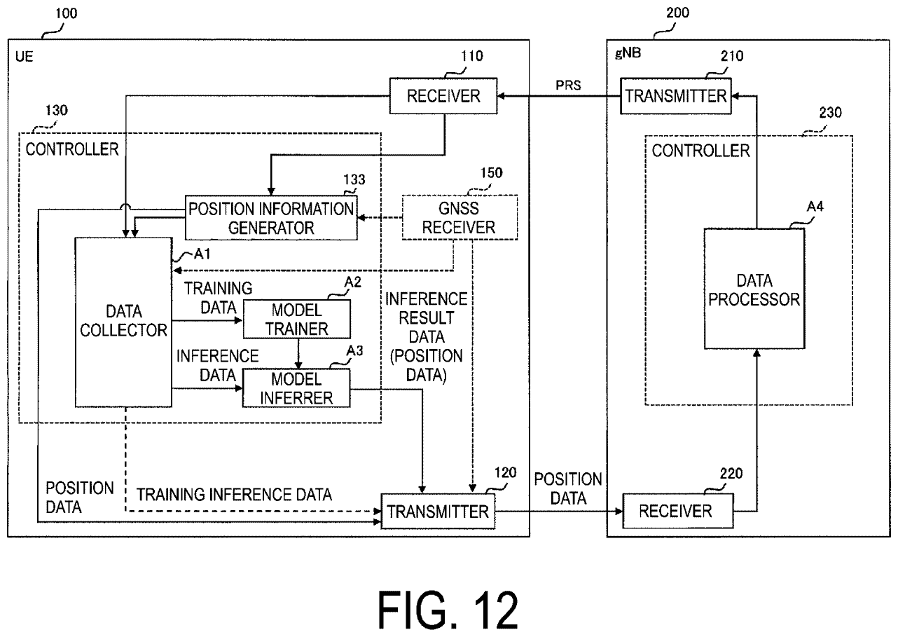

FIG. 12 is a diagram illustrating an arrangement example of the functional blocks in the “positioning accuracy improvement”. In the example of the “positioning accuracy improvement” illustrated in FIG. 12, the controller 130 of the UE 100 includes the data collector A1, the model trainer A2, and the model inferrer A3. On the other hand, the controller 230 of the gNB 200 includes the data processor A4. In other words, FIG. 12 illustrates an example in which the UE 100 perform model training and model inference. FIG. 12 illustrates an example in which the transmission entity TE is the UE 100 and the reception entity RE is the gNB 200.

As illustrated in FIG. 12, the UE 100 includes a position information generator 133. The UE 100 may include a Global Navigation Satellite System (GNSS) receiver 150. The position information generator 133 generates position data of the UE 100 based on a Positioning Reference Signal (PRS) (full PRS or partial PRS) received from the gNB 200. The position information generator 133 may receive a GNSS signal (full GNSS signal or partial GNSS signal) received by the GNSS receiver 150 and generate the position data of the UE 100 based on the GNSS signal.

Similar to the full CSI-RS, the gNB 200 transmits the full PRS using a predetermined amount of first resources (for example, all antenna ports or a predetermined amount of time frequency resources). Further, similar to the partial CSI-RS, the gNB 200 transmits the partial PRS by using the second resource (for example, half the antenna ports in the antenna panel or half the predetermined amount of time-frequency resources) having the smaller amount of resources than the first resources.

The full GNSS signal may be a GNSS signal temporally continuously received by the GNSS receiver 150. The partial GNSS signal may be a GNSS signal intermittently received by the GNSS receiver 150. In other words, a predetermined amount of first resources may be used for the full GNSS signal, and the second resources the amount of which is smaller than that of the first resources may be used for the partial GNSS signal.

An operation example in the “positioning accuracy improvement” can be implemented by replacing the “full CSI-RS” with the “full PRS”, the “partial CSI-RS” with the “partial PRS”, and the “CSI feedback” with the “position data” in FIG. 10.

In the training mode (step S103), the position information generator 133 generates the position data of the UE 100 based on the full PRS received from the gNB 200. The position information generator 133 may receive a full GNSS signal received by the GNSS receiver 150 and generate the position data of the UE 100 based on the full GNSS signal. The transmitter 120 feeds back (or transmits) the position data to the gNB 200. The data collector A1 collects the full PRS (or the full GNSS signal) and the position data. The model trainer A2 generates a trained model using the full PRS (or the full GNSS signal) and the position data as training data.

In the inference mode (step S108), the data collector A1 collects the partial PRS received by the receiver 110 (or the partial GNSS signal received by the GNSS receiver 150). The model inferrer A3 causes the partial PRS (or the partial GNSS signal) and the position data to be input to the trained model as inference data, and obtains the position data as an inference result. The UE 100 transmits the inference result (position data) to the gNB 200 as inference result data.

In the “positioning accuracy improvement”, in addition to the “PRS”, the “GNSS signal”, and the “position data”, for example, the following data and/or information may be used as the data used for the dataset.
(Z1) RSRP, RSRQ, Signal-to-interference-plus-noise ratio (SINR), or the output waveform of the AD converter (a measurement target of these data may be the PRS. The measurement target may be other reception signals received from the gNB 200)
(Z2) Line Of Sight (LOS) or Non Line Of Sight (NLOS)
(Z3) Measurement timing, accuracy, likelihood
(Z4) RF fingerprint (cell ID and reception quality in the cell having the cell ID)
(Z5) Angle of Arrival (AOA) of a reception signal, a reception level for each antenna, a reception phase for each antenna, and an Observed Time Difference Of Arrival (OTDOA) for each antenna
(Z6) Reception information of a beacon used in short-range wireless communication such as wireless Local Area Network (LAN) such as Wi-Fi (registered trademark), or Bluetooth (registered trademark)
(Z7) Moving speed of the UE 100 (the moving speed may be measured by the GNSS receiver 150. The moving speed may be measured by a speed sensor in the UE 100) The UE 100 may transmit capability information as the control data to the gNB 200, the capability information indicating which type of input data the UE 100 can handle in the machine learning. The capability information may include any information or data from among (Z1) to (Z7). Aside from the training data and the inference data, the capability information may include any information or data from among (Z1) to (Z7). The gNB 200 may transmit, to the UE 100 as the control data, the data type information used as a dataset. The data type information may include, for example, any of the data or information indicated in (Z1) to (Z7). Aside from the training data and the inference data, the data type information may include any information or data from among (Z1) to (Z7).

### (1.4) Other Arrangement Examples

Other arrangement examples will be described next.

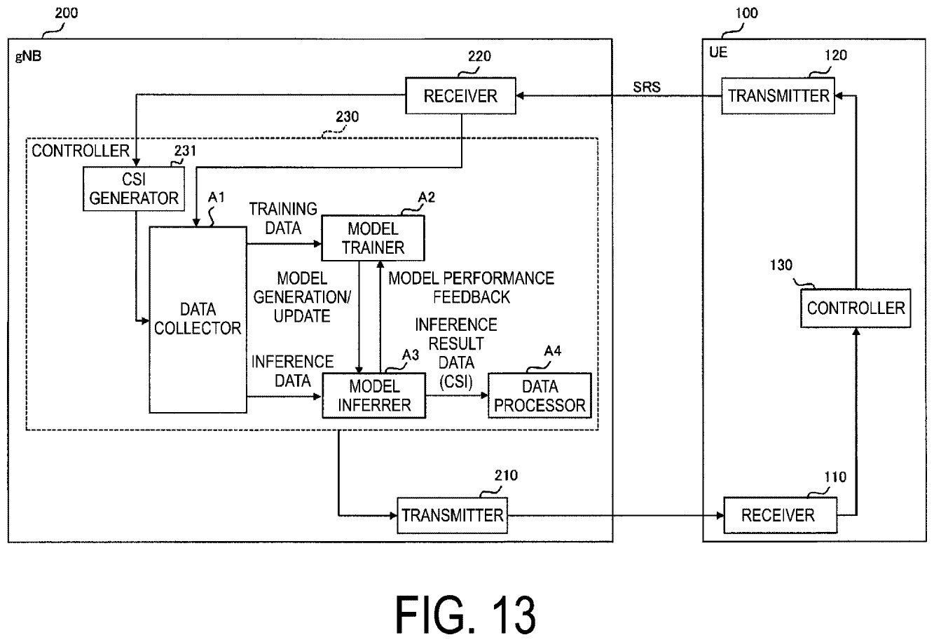

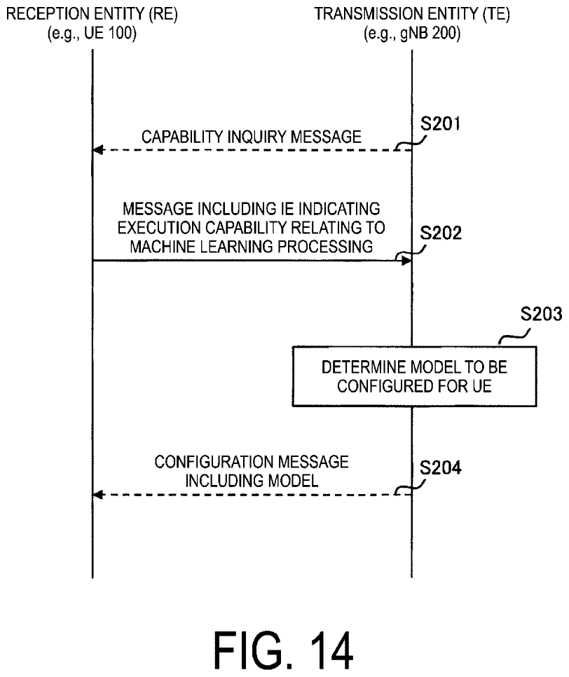

FIG. 13 is a diagram illustrating another arrangement example of the “CSI feedback enhancement” according to the first embodiment. FIG. 13 illustrates an example in which the gNB 200 includes the data collector A1, the model trainer A2, the model inferrer A3, and the data processor A4. In other words, FIG. 14 illustrates an example in which the gNB 200 performs model training and model inference. FIG. 14 illustrates an example in which the transmission entity TE is the gNB 200 and the reception entity RE is the UE 100.

FIG. 13 illustrates an example in which the AI/ML technology is introduced into CSI estimation performed by a gNB 200 based on a Sounding Reference Signal (SRS). Thus, the gNB 200 includes a CSI generator 231 that generates CSI based on the SRS. The CSI is information indicating an uplink channel state between the UE 100 and the gNB 200. The gNB 200 (e.g., the data processor A4) performs, for example, uplink scheduling based on the CSI generated based on the SRS.

### (1.5) Model Transfer Example

In (1.1) to (1.4), the arrangement example of the functional blocks of the AI/ML technology has been described. Model transfer will be described below. The model to be transferred may be a trained model used in the model inference. The model may be an untrained model used in the model training (or a model being trained).

### (1.5.1) First Operation Pattern Relating to Model Transfer

FIG. 14 is a diagram illustrating an operation example of a first operation pattern relating to model transfer according to the first embodiment. In the example illustrated in FIG. 14, the reception entity RE is mainly described as the UE 100. However, the reception entity RE may be the gNB 200 or AMF 300. In the example illustrated in FIG. 14, the transmission entity TE is mainly described as the gNB 200. However, the transmission entity TE may be the UE 100 or AMF 300.

As illustrated in FIG. 14, in step S201, the gNB 200 transmits, to the UE 100, a capability inquiry message for requesting transmission of the message including the information element (IE) indicating the execution capability relating to the machine learning processing. The UE 100 receives the capability inquiry message. However, the gNB 200 may transmit the capability inquiry message when performing the machine learning processing (when determining to perform the machine learning process).

In step S202, the UE 100 transmits, to the gNB 200, the message including the information element indicating the execution capability (an execution environment for the machine learning processing, from another viewpoint) relating to the machine learning processing. The gNB 200 receives the message. The message may be an RRC message, for example, a “UE Capability” message or a newly defined message (e.g., a “UE AI Capability” message or the like). Alternatively, the transmission entity TE may be the AMF 300 and the message may be a NAS message. Alternatively, when a new layer for performing or controlling the machine learning processing (AI/ML processing) is defined, the message may be a message of the new layer.

The information element indicating the execution capability relating to the machine learning processing may be an information element indicating capability of a processor for performing the machine learning processing and/or an information element indicating capability of a memory for performing the machine learning processing. Specifically, the information element indicating the capability of the processor may be an information element indicating a product number (or model number) of an AI processor. Specifically, the information element indicating the capability of the memory may be an information element indicating the memory capacity.

Alternatively, the information element indicating the execution capability relating to the machine learning processing may be an information element indicating the execution capability of the inference processing (model inference). The information element indicating the execution capability of the inference processing may be, specifically, an information element indicating whether a deep neural network model can be supported. The information element may be an information element indicating the time (or response time) required to execute the inference processing.

Alternatively, the information element indicating the execution capability relating to the machine learning processing may be an information element indicating the execution capability of the learning processing (model training). The information element indicating the execution capability of the learning processing may be, specifically, an information element indicating the number of simultaneous executions of the learning processing. The information element may be an information element indicating the processing capacity of the learning processing.

In step S203, the gNB 200 determines a model to be configured (deployed) for the UE 100 based on the information element included in the message received in step S202.

In step S204, the gNB 200 transmits, to the UE 100, a message including the model determined in step S203. The UE 100 receives the message and performs the machine learning processing (i.e., model training processing and/or model inference processing) using the model included in the message. A specific example of step S204 will be described in a second operation pattern below.

### (1.5.2) Second Operation Pattern Relating to Model Transfer

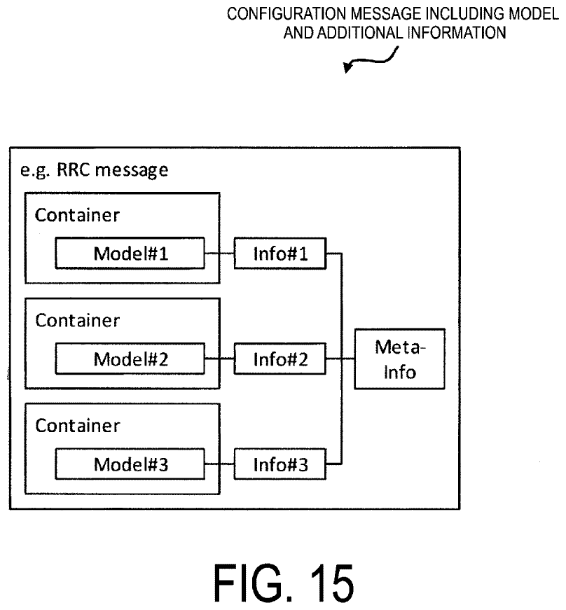

FIG. 15 is a diagram illustrating an example of a configuration message including models and additional information according to the first embodiment. The configuration message may be an RRC message transmitted from the gNB 200 to the UE 100 (for example, an “RRC Reconfiguration” message, or a newly defined message (for example, an “AI Deployment” message, an “AI Reconfiguration” message, or the like)). Alternatively, the configuration message may be a NAS message transmitted from the AMF 300 to the UE 100. Alternatively, when a new layer for performing or controlling the machine learning processing (AI/ML processing) is defined, the message may be a message of the new layer.

In the example of FIG. 15, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (for example, processing delay) required for applying (executing) the model.

The individual additional information or the common additional information may be a model application designating a function to which the model is applied (for example, “CSI feedback”, “beam management”, “position measurement”, or the like). The individual additional information or the common additional information may be a model selection criterion for applying (executing) a corresponding model in response to satisfaction of a designated criterion (for example, a moving speed).

### (1.6) Configuration Example of Functional Blocks

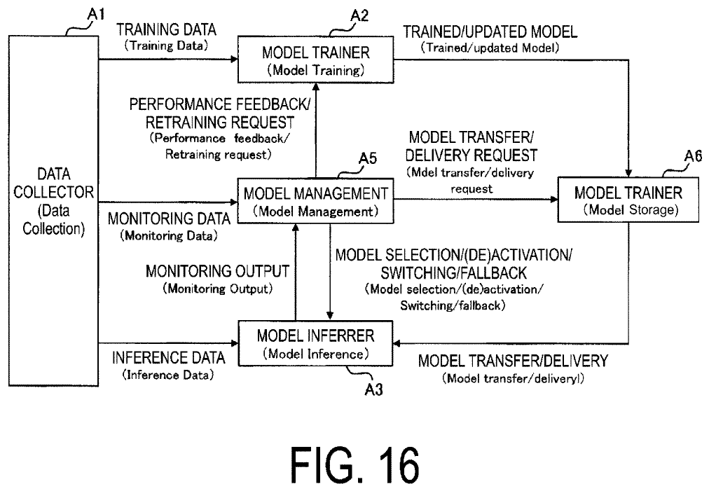

Functional blocks for AI for wireless communication has been described with reference to FIG. 7. At present, in 3GPP, a block diagram illustrated in FIG. 16 is being considered regarding functional blocks for AI for wireless communication.

FIG. 16 is a diagram illustrating a configuration example of the functional blocks according to the first embodiment. In the functional block diagram illustrated in FIG. 16, a model manager A5 and a model recorder A6 are further included compared with the functional block diagram illustrated in FIG. 7.

The model manager A5 manages an AI/ML model. For example, the model manager A5 requests the model trainer A2 to retrain the trained model, or requests the model recorder A6 to perform model transfer. As illustrated in FIG. 16, an AI/ML model that has become trained by re-training may be referred to as an updated model. Also, for example, the model manager A5 instructs (or requests) the model inferrer A3 to perform model selection, model (de)activation, model switching, and/or fallback. The model manager A5 may evaluate the performance of the trained model by using monitoring data acquired from the data collector A1 and monitoring output acquired from the model inferrer A3, and request re-training or instruct model switching based on a result of the evaluation.

The model recorder A6 functions as a reference point in the functional blocks. Therefore, the model recorder A6 need not record the trained model or the updated model on a recording medium.

How the functional blocks illustrated in FIG. 16 are disposed in each use case is under consideration in 3GPP.

Hereinafter, the AI/ML model that is a training target may be referred to as a “trained model,” a trained AI/ML model may be referred to as a “trained model,” and an AI/ML model after re-training has been performed may be referred to as a “updated model,” respectively. In the model inferrer A3, model inference is performed using the trained model or the updated model. Also, data for inference may be referred to as inference data, and data for training may be referred to as training data.

### (1.7) Transmission Entity TE and Reception Entity RE

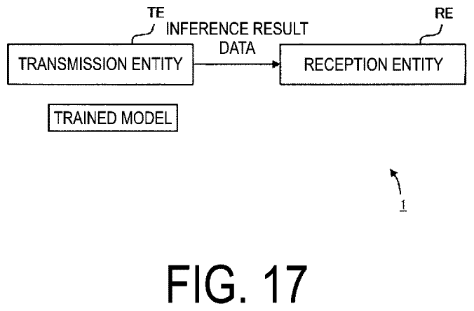

FIG. 17 is a diagram illustrating a configuration example of a mobile communication system 1 according to the first embodiment.

As described above, the transmission entity TE is a block that performs model inference using the trained model. The transmission entity TE performs the inference using the trained model to acquire the inference result data. The transmission entity TE is capable of transmitting the inference result data to the reception entity RE. However, the transmission entity TE may use the inference result data by itself without transmitting the inference result data to the reception entity RE.

The reception entity RE does not perform the inference using the trained model. When the inference result data is transmitted from the transmission entity TE, the reception entity RE can receive the inference result data.

In the first embodiment, derivation of the trained model (that is, execution of model training) may be performed in the transmission entity TE. The derivation of the trained model may be performed in the reception entity RE. When the trained model is derived in the reception entity RE, the reception entity RE transmits the trained model to the transmission entity TE.

### (2) Communication Control Method According to First Embodiment

Next, a communication control method according to the first embodiment will be described.

In the first embodiment, attention is focused on a use case of “positioning accuracy improvement.”

As described above, in the use case of “positioning accuracy improvement,” the UE 100 uses the PRS transmitted from the gNB 200. As issues when the PRS is used, for example, the following exist.

That is, for estimation of the position information of the UE 100 using the PRS, a triangulation technique is used. For example, the UE 100 acquires a reception time difference (OTDOA) with respect to the gNB 200-1 and a reception time difference with respect to the gNB 200-2 based on the PRSs from at least two known gNBs 200-1 and 200-2, and transmits these to the LMF 400 via the gNB 200. In the LMF 400, the position of the UE 100 is estimated based on at least two reception time differences.

Thus, in position estimation using the PRS, PRSs transmitted from at least two gNBs 200 are used. Therefore, it is necessary to transmit PRS, which is a special signal, from the gNB 200, and there is a possibility that communication resources of the gNB 200 are temporarily occupied exclusively.

Therefore, it is expected that the position of the UE 100 is estimated by AI/ML technology using the RF fingerprint of a signal constantly transmitted from one or more gNBs 200 (for example, system information or the like) instead of the PRS, which is a special signal.

The RF fingerprint is, for example, information provided by the UE 100 and represents measurement information for one or more neighboring cells. The RF fingerprint is used, for example, to estimate the position of the UE 100. Specifically, the RF fingerprint includes a cell ID, RSSI, TA, SNR, and a used frequency. The RF fingerprint may be represented by RSSI for each cell ID, TA for each cell ID, SNR for each cell ID, or the used frequency for each cell ID. The RF fingerprint may be the RF fingerprint for one or more gNBs 200.

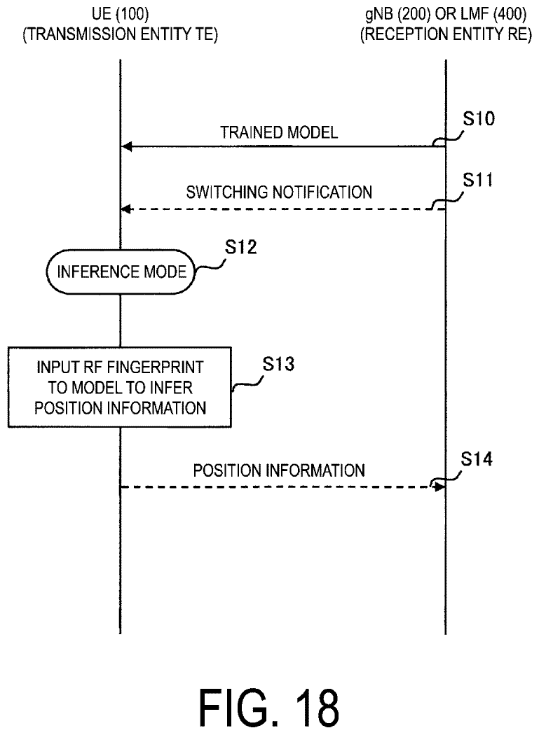

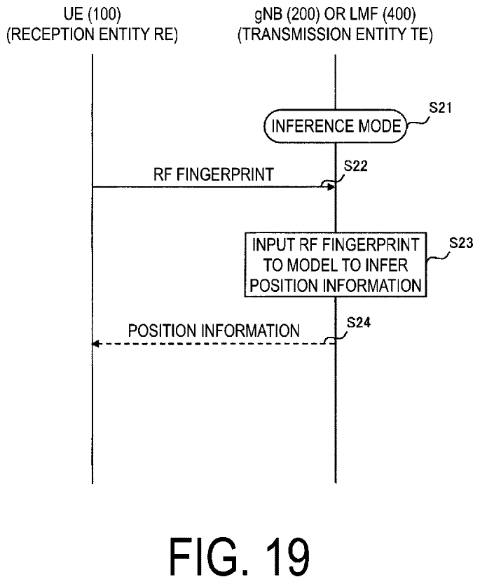

FIGS. 18 and 19 are diagrams showing an operation example according to the first embodiment. FIGS. 18 and 19 show an operation example in a case in which the RF fingerprint is used in the use case of “positioning accuracy improvement.” Among these, FIG. 18 shows an operation example in a case in which the transmission entity TE is the UE 100 and the reception entity RE is the gNB 200 (or the LMF 400). Before the operation example illustrated in FIG. 18 is performed, model training for the trained model is performed in the reception entity RE, and the trained model is derived in the reception entity RE. Also, in FIGS. 18 and 19, the UE 100 is assumed to be in a situation in which the UE 100 does not included a GNSS receiver 150 mounted thereon, or cannot receive a GNSS signal due to being underground or the like.

As illustrated in FIG. 18, in step S10, the reception entity RE transmits the trained model to the transmission entity TE. When the reception entity RE is the gNB 200, the gNB 200 may transmit control data including the trained model. When the reception entity RE is the LMF 400, the LMF 400 may transmit an LPP message including the trained model to the UE 100.

In step S11, the reception entity RE may transmit, to the transmission entity TE, a switching notification from a training mode to an inference mode. The gNB 200 may transmit control data including the switching notification to the UE 100. The LMF 400 may transmit an LPP message including the switching notification to the UE 100. The LMF 400 may transmit the switching notification in response to receiving a switching request transmitted from the UE 100.

In step S12, the transmission entity TE transitions to the inference mode. The transmission entity TE may transition to the inference mode in response to receiving the switching notification.

In step S13, the transmission entity TE inputs the RF fingerprint as inference data to the trained model, and estimates the position information from the trained model.

In step S14, the transmission entity TE may transmit the position information to the reception entity RE. The UE 100 may transmit control data including the position information to the gNB 200. The UE 100 may transmit an LPP message including the position information to the LMF 400. The transmission entity TE may use the position information by itself. The transmission entity TE may transmit the position information to a core network apparatus (or an external application server) other than the LMF 400, which requests acquisition of the position information.

FIG. 19 shows an operation example in a case in which the transmission entity TE is the gNB 200 (or the LMF 400) and the reception entity RE is the UE 100. In the example illustrated in FIG. 19, model training is assumed to be performed in the transmission entity TE.

As illustrated in FIG. 19, in step S21, the transmission entity TE transitions to the inference mode.

In step S22, the reception entity RE transmits the RF fingerprint to the transmission entity TE. The UE 100 may transmit a control message including the RF fingerprint to the gNB 200. The UE 100 may transmit an LPP message including the RF fingerprint to the LMF 400. The reception entity RE may transmit the RF fingerprint in accordance with the RF fingerprint transmission instruction received from the transmission entity TE.

In step S23, the transmission entity TE inputs the RF fingerprint to the trained model, and infers the position information from the trained model.

In step S24, the transmission entity TE may transmit the position information to the reception entity RE. The gNB 200 may transmit a control message including the position information to the UE 100. The transmission entity TE, namely, the LMF 400 may transmit an LPP message including the position information to the UE 100. The transmission entity TE may use the position information by itself.

As described with reference to FIGS. 18 and 19, in the use case of “positioning accuracy improvement,” it is possible to use the RF fingerprint as inference data for AI/ML technology.

In general, the accuracy (or reliability) of the trained model relates to how closely inference result data output from the trained model approximates data acquired without using the AI/MWL model. An operation of acquiring the data without using the AI/ML model is hereinafter referred to as a “legacy operation.” In the use case of “positioning accuracy improvement,” for example, the legacy operation is as follows. That is, the legacy operation is an operation of acquiring a GNSS signal by using the GNSS receiver 150 and acquiring the position information based on the GNSS signal. Alternatively, the legacy operation may be an operation in which the LMF 400 calculates the position information based on the OTDOA or the like.

As described above, the accuracy (or reliability) of the trained model relates to how closely inference result data inferred from the trained model approximates data acquired through the legacy operation. Therefore, in order to determine the accuracy of the trained model, it is desirable to perform the legacy operation at an appropriate timing and to compare inference result data of the trained model with the data acquired through the legacy operation. Causing the legacy operation to be performed to acquire data and comparing the data with inference result data may be referred to as “monitoring.” “Monitoring” may be causing the legacy operation to be performed. In FIG. 16, monitoring is performed in the model manager A5. In this case, monitoring data corresponds to “the data acquired through the legacy operation,” and monitoring output can correspond to “inference result data.”

Monitoring is preferably performed at an appropriate timing. For example, when a monitoring interval is less than a predetermined value, the frequency of monitoring increases compared with a case in which the monitoring interval is equal to or greater than the predetermined value, and therefore, the number of comparisons between inference result data of the trained model and the data acquired through the legacy operation increases and it is expected that degradation in accuracy of the inference result can be detected early. On the other hand, when the monitoring interval is less than the predetermined value, a communication frequency also increases compared with a case in which the monitoring interval is equal to or greater than the predetermined value, and thus communication resources increase.

On the other hand, when the monitoring interval is equal to or greater than the predetermined value, consumption of communication resources can be suppressed compared with a case in which the monitoring interval is less than the predetermined value, but it is expected that detection of degradation in accuracy of the inference result takes time.

Therefore, in the first embodiment, it is an object to perform monitoring at an optimal timing.

Therefore, in the first embodiment, any of the transmission entity TE or the reception entity RE (for example, the UE 100) determines to start monitoring of the trained model, based on training record data obtained by compressing training data used when causing the AI/ML model to undergo model training.

For example, assume a case in which model training is performed when the RF fingerprints are included in training data. Here, the training data includes ground truth data and input data. The input data may be used as inference data for model inference. The RF fingerprint corresponds to input data of the training data.

When the UE 100 moves to a location at which model training has not been performed in the past, an acquired RF fingerprint can become the RF fingerprint that has not been used for past model training. That is, when the UE 100 determines that the currently acquired RF fingerprint is not included in the training record data, the UE 100 is estimated to have moved to the location at which model training has not been performed in the past. When the model inference is performed in a case in which the UE 100 has moved to the location at which model training has not been performed in the past, accuracy (or reliability) of the position information, which is inference result data, may become problematic. Therefore, in the first embodiment, monitoring is performed when it is confirmed that the UE 100 is at the location at which inference has not been performed in the past. Accordingly, for example, in the mobile communication system 1, monitoring can be performed at an appropriate timing (that is, a timing at which it is confirmed that the UE 100 is at the location at which inference has not been performed in the past).

Hereinafter, details of an operation example according to the first embodiment will be described. In the operation example according to the first embodiment, the use case of “positioning accuracy improvement” is used for description. Also, as the training data, the RF fingerprint (input data) and the position information (ground truth data) are used in the following description. Further, the UE 100 is assumed to be in a situation where the UE 100 does not include the GNSS receiver 150 mounted thereon, or even when the UE 100 includes the GNSS receiver 150 mounted thereon, the UE 100 cannot receive a GNSS signal due to being underground or the like. Accordingly, the UE 100 acquires the position information by using wireless communication with one or more gNBs 200.

Regarding the operation example, first, an operation example (first operation example) will be described in which the transmission entity TE is the UE 100 and the reception entity RE is the LMF 400. Next, an operation example (second operation example) will be described in which the transmission entity TE is the LMF 400 and the reception entity RE is the UE 100.

### (2.1) First Operation Example

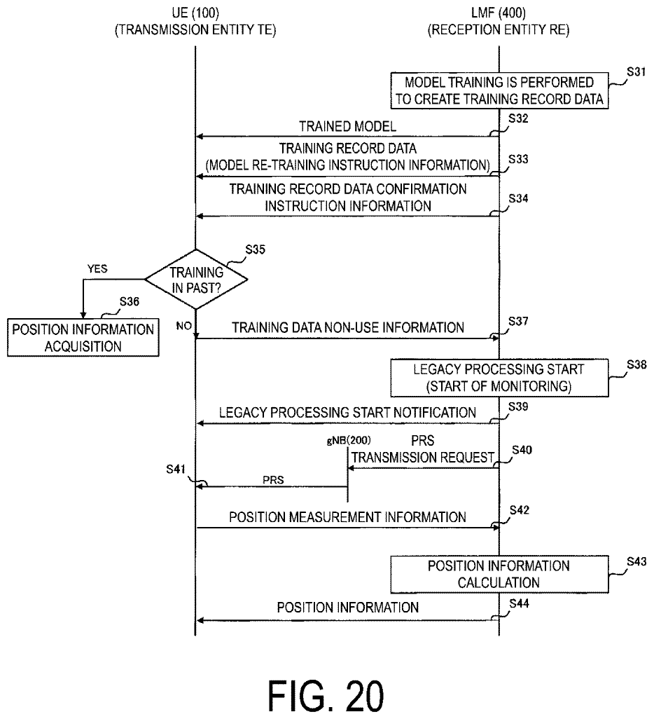

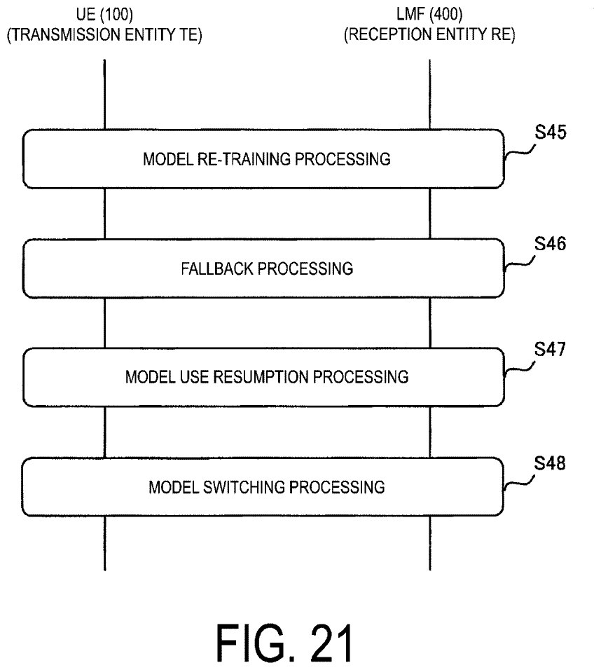

FIGS. 20 and 21 are diagrams showing the first operation example according to the first embodiment. As illustrated in FIGS. 20 and 21, an operation example is shown in which the UE 100 is the transmission entity TE and the LMF 400 is the reception entity RE. As illustrated in FIGS. 20 and 21, various types of data and the like are transmitted between the UE 100 and the LMF 400, and all of these are performed using the LPP message. In the following description, description will be given in a state in which the use of the LPP message is omitted. However, an NRPPa message is used between the LMF 400 and the gNB 200, and a control message or U-plane message may be used between the gNB 200 and the UE 100.

As illustrated in FIG. 20, in step S31, the LMF 400 performs model training using training data and derives the trained model. The training data includes, for example, the RF fingerprints (input data) and the position information (ground truth data). The LMF 400 may acquire the RF fingerprint and the position information from the UE 100 in advance.

Also, in step S31, the LMF 400 compresses training data used for model training to create training record data. For example, when training data is stored as it is, a large amount of training data is stored, and therefore, compression of the training data is performed. For the compression of training data, a known Bloom filter may be used. For example, the LMF 400 stores training data once in a memory using a Bloom filter, discards training data when identical training data is used, and stores training data when non-identical training data is used. Accordingly, it becomes possible to create training record data representing compressed training data. The training record data may include identification information (for example, a model ID) of the AI/NIL model for which the training data has been used.

In step S32, the LMF 400 transmits the trained model to the UE 100. The UE 100 receives the trained model.

In step S33, the LMF 400 transmits the training record data to the UE 100. When the LMF 400 determines that input data has not been used for model training of the trained model, the LMF 400 may transmit, to the UE 100, information for instructing re-training of the trained model (hereinafter, sometimes referred to as “model re-training instruction information”). The LMF 400 may transmit the training record data and the model re-training instruction information in a single message. The UE 100 receives at least the training record data.

In step S34, the LMF 400 transmits, to the UE 100, information indicating an instruction to confirm the training record data (hereinafter, sometimes referred to as “training record data confirmation instruction information”). The LMF 400 may transmit the training record data, the model re-training instruction information, and the training record data confirmation instruction information in a single message. The UE 100 receives the training record data confirmation instruction information.

In step S35, the UE 100 determines, in accordance with the training record data confirmation instruction information, whether (currently) acquired input data has been used for (past) model training based on the training record data. Specifically, the UE 100 may perform the determination based on whether the acquired input data (the RF fingerprint) is included in the training record data. When the UE 100 determines that the acquired input data has been used for model training (YES in step S35), the processing proceeds to step S36. On the other hand, when the UE 100 determines that the input data has not been used for model training (NO in step S35), the processing proceeds to step S37.

In step S36, the UE 100 performs model inference using the trained model and acquires the position information. When the UE 100 determines that the acquired RF fingerprint has been used in past training, the UE 100 is estimated to be at a location at which training has been performed in the past. Therefore, the UE 100 acquires the position information by directly using a result of the inference.

On the other hand, in step S37, the UE 100 transmits, to the LMF 400, information indicating that the acquired input data has not been used for model training (hereinafter, sometimes referred to as “training data non-use information”). the LMF 400 receives the training data non-use information.

In step S38, the LMF 400 determines to start monitoring of the trained model in response to receiving the training data non-use information. That is, when the UE 100 determines, based on the training record data, that the current location is the location at which model training has not been performed (NO in step S35), the LMF 400 determines to start monitoring (that is, to start legacy processing) using reception of the training data non-use information as a trigger.

In step S39, the LMF 400 transmits, to the UE 100 and the gNB 200, a legacy processing start notification indicating to start legacy processing. The UE 100 and the gNB 200 receive the legacy processing start notification.

In step S40, the LMF 400 transmits a PRS transmission request to the gNB 200.

In step S41, the gNB 200 transmits the PRS in response to receiving the PRS transmission request.

In step S42, the UE 100 generates the position measurement information based on the PRS and transmits the position measurement information to the LMF 400. The position measurement information is, for example, information measured based on the PRS in the UE 100 and is measurement information used to calculate the position information in the LMF 400. The position measurement information includes, for example, a direction of arrival of PRS (DL-AOA), a reception phase for each antenna, or a reception time difference (DL-TDOA). The LMF 400 receives the position measurement information.

In step S43, the LMF 400 calculates the position information of the UE 100 based on the position measurement information.

In step S44, the LMF 400 transmits the position information to the UE 100.

In step S45 (FIG. 21), the UE 100 and the LMF 400 perform model re-training processing.

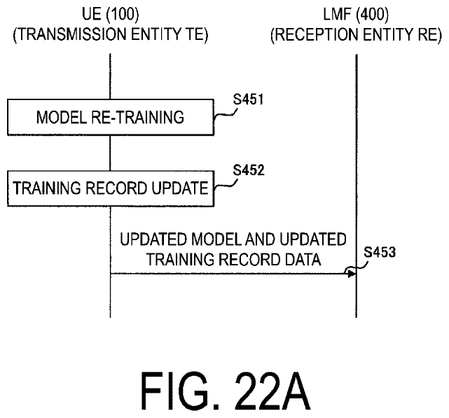

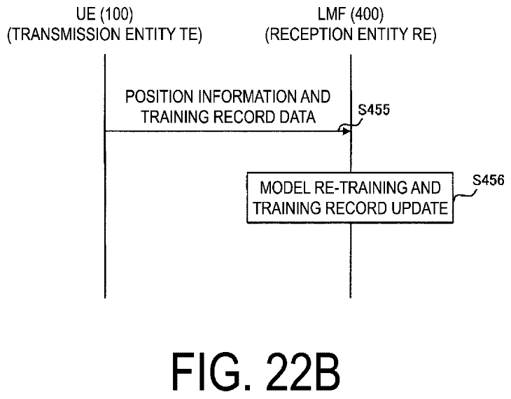

FIG. 22A is a diagram illustrating an operation example of the model re-training processing according to the first embodiment. As illustrated in FIG. 22, in step S451, the UE 100 performs re-training of the trained model in accordance with the model re-training instruction information (step S33) because the UE 100 has determined that the acquired input data has not been used for past model training (NO in step S35). That is, when the UE 100 confirms, based on the training record data, that the acquired input data has not been used for past model training, the UE 100 performs re-training. The UE 100 performs re-training of the trained model using, as the training data, the position information (ground truth data) acquired in step S44 and the RF fingerprint (input data) used in the determination in step S35. The trained model after re-training may become the updated model. Alternatively, the UE 100 performs inference using the RF fingerprint used in the determination in step S35, and compares a result obtained through the inference with the position information (ground truth data) acquired in step S44. When an error is smaller than a predetermined error as a result of the comparison, the UE 100 may omit the model re-training in step S451. Since the inference result by the RF fingerprint used in the determination in step S35 may have a certain level of accuracy, the model re-training (step S451) may be omitted in such a case.

In step S452, the UE 100 updates the training record data using the training data used for re-training.

In step S453, the UE 100 transmits the updated model and the updated training record data to the LMF 400. The transmission may be performed based on an instruction from the LMF 400. For example, the LMF 400 may instruct a transmission timing of the updated model and the updated training record data. The transmission timing may be, for example, when the number of updates exceeds a threshold number (for example, ten times). Alternatively, the transmission timing may be designated based on an interval or a time. Alternatively, the transmission timing may be set to an arbitrary timing based on an update notification from the UE 100.

Although, in FIG. 22A, an example has been described in which model re-training is performed in the UE 100; model re-training may be performed in the LMF 400 in consideration of the fact that derivation of the trained model is performed in the LMF 400. FIG. 22B is a diagram illustrating an operation example in a case in which the model re-training is performed in the LMF 400.

As illustrated in FIG. 22B, in step S455, the UE 100 transmits, to the LMF 400, the position information acquired in step S44 and the training record data acquired in step S33. The transmission of the position information and the training record data in the UE 100 may be a request for re-training (and updating of the training record data) to the LMF 400. A timing of updating the training record data is implementation dependent, but may be, for example, when the number of updates exceeds an update threshold. The timing may be designated by an interval, a time, or the like. The timing may be immediate updating. In step S456, the LMF 400 performs re-training of the trained model using the position information and updates the training record data.

Returning to FIG. 21, in step S46, the UE 100 and the LMF 400 perform fallback processing.

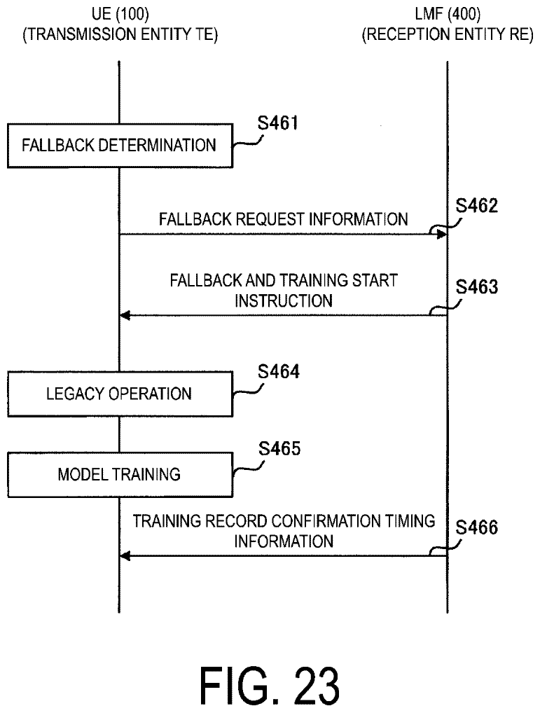

FIG. 23 is a diagram illustrating an operation example of the fallback processing according to the first embodiment. As illustrated in FIG. 23, in step S461, the UE 100 performs a fallback determination. The UE 100 determines whether to perform fallback, based on the training record data updated by re-training. Specifically, the UE 100 may determine to perform fallback when detecting the following based on the training record data.
(B1) There is no cell ID of the serving cell (for example, no cell ID is included at all in the training record data).
(B2) There is no currently used frequency (for example, no currently used frequency is included at all in the training record data).
   In step S462, when the UE 100 determines to perform the fallback, the UE 100 transmits, to the LMF 400, information indicating a fallback request (hereinafter, sometimes referred to as “fallback request information”).

In step S463, the LMF 400 transmits, to the UE 100, information for instructing the UE 100 to perform the fallback (hereinafter, sometimes referred to as “fallback instruction information”) in response to receiving the fallback request information, and also transmits, to the UE 100, information for instructing that model training is performed during fallback execution (hereinafter, sometimes referred to as “training start instruction information”). The instruction to start the model training during fallback is intended to enable the resumption of the use by a new trained model (described later) by causing model training to be performed at a location at which training has not been performed in the past, in which the UE 100 is at the location (NO in step S35). The fallback instruction information may include deactivation of the trained model and an instruction to start use of the legacy operation.

In step S464, the UE 100 performs the legacy operation in accordance with the fallback instruction information (step S463). For example, the UE 100 and the LMF 400 perform operations from step S40 to step S44 as the legacy operation. The UE 100 acquires the position information from the LMF 400 through the legacy operation.

In step S465, the UE 100 performs model training using, as the training data, the position information acquired in step S464 and the input data used in the determination in step S35. Since the UE 100 is located at the location at which model training has not been performed in the past, the UE 100 performs model training using the RF fingerprint (acquired from one or more gNBs 200) and the position information obtained at that location.

In step S466, the LMF 400 transmits, to the UE 100, information indicating a training record confirmation timing (hereinafter, sometimes referred to as “training record confirmation timing information”). The training record confirmation timing is used for determination of the resumption of the use of the trained model to be described later. The training record confirmation timing includes, for example, a timing designated by the LMF 400. The training record confirmation timing may be designated as a time interval. The training record confirmation timing may be an instruction to update (or acquire) the training record data. The UE 100 receives training record confirmation timing information.

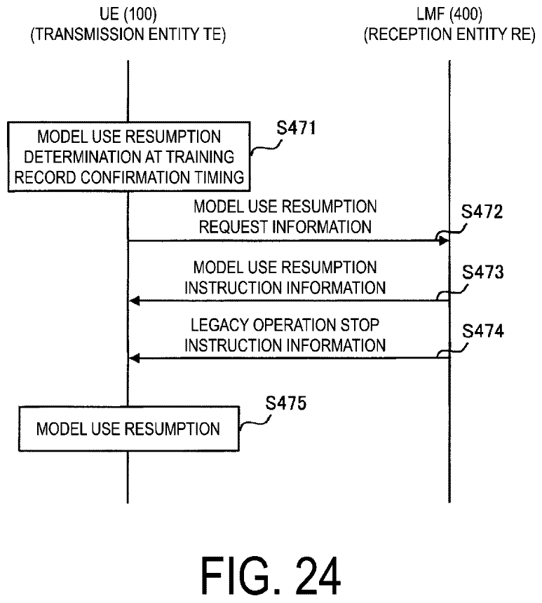

Returning to FIG. 21, in step S47, the UE 100 performs model use resumption processing. FIG. 24 is a diagram illustrating an operation example of the model use resumption processing according to the first embodiment. The UE 100 is assumed to be executing fallback.

As illustrated in FIG. 24, in step S471, at the training record confirmation timing, the UE 100 confirms the training record data and determines, based on the training record data, the resumption of the use of the trained model derived by model training performed during fallback (step S465 in FIG. 23). Specifically, the UE 100 determines to perform resumption of the use of the trained model when at least any of the following can be confirmed based on the training record data.
(C1) Cell ID of Serving Cell
(C2) Currently used frequency
   In step S472, when the UE 100 determines to perform resumption of the use of the trained model, the UE 100 transmits, to the LMF 400, information indicating a request for resumption of the model use (hereinafter, sometimes referred to as “model use resumption request information”). The model use resumption request information may include a model ID of a model that is a resumption target. The UE 100 receives the model use resumption request information.

In step S473, the LMF 400 transmits, to the UE 100, information for instructing resumption of model use (hereinafter, sometimes referred to as “model use resumption instruction information”) in response to receiving the model use resumption request information. The model use resumption instruction information may include a model ID of a model that is a resumption target. The model use resumption instruction information may be information for instructing activation of the trained model. The UE 100 receives the model use resumption instruction information.

In step S474, the LMF 400 transmits, to the UE 100, information indicating an instruction to stop the legacy operation (hereinafter, sometimes referred to as “legacy operation stop instruction information”). The UE 100 receives the legacy operation stop instruction information.

In step S475, the UE 100 resumes use of the trained model in response to the reception of the model use resumption instruction information, and stops the legacy operation in response to receiving the legacy operation stop instruction information.

Returning to FIG. 21, in step S48, the UE 100 and the LMF 400 may perform model switching processing.

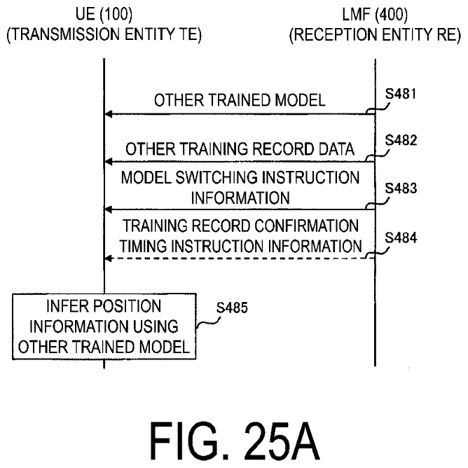

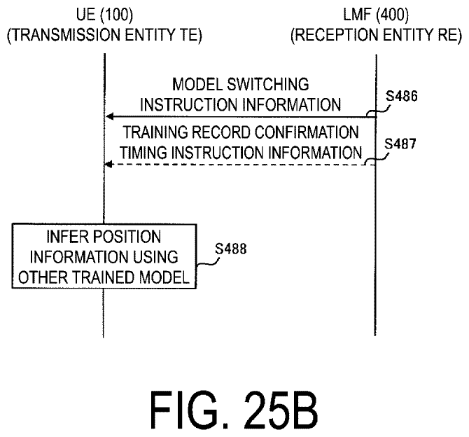

FIG. 25A is a diagram illustrating an operation example of the model switching processing according to the first embodiment. For example, the LMF 400 acquires the position information of the UE 100 through the legacy operation. Also, the LMF 400 may derive the trained model that is optimal for the UE 100 based on the position information. Accordingly, the LMF 400 may transmit, to the UE 100, another trained model different from the trained model used for inference in the UE 100 (step S481). In this case, the LMF 400 transmits, to the UE 100, other training record data obtained by compressing training data used for the other trained model (step S482), and further transmits, to the UE 100, information indicating an instruction to switch to the other trained model (hereinafter, sometimes referred to as “model switching instruction information”) (step S483). Further, the LMF 400 may transmit, to the UE 100, training record confirmation timing instruction information indicating a timing at which the training record data is confirmed (step S484). The UE 100 switches to the other trained model in accordance with the model switching instruction information, and infers the position information using the other trained model (step S485).

Although, in FIG. 25A, an example has been described in which the LMF 400 transmits another trained model to the UE 100; the UE 100 may hold the other trained model, as illustrated in FIG. 25B. Accordingly, the LMF 400 may transmit, to the UE 100, the model switching instruction information for instructing the other trained model (step S486). The LMF 400 may request the UE 100 to provide holding information of the trained model in order to confirm whether the UE 100 holds the other trained model. The UE 100 may transmit identification information of the trained model held by the UE 100 to the LMF 400 in accordance with the request. The model switching instruction information may include a model ID of a trained model that is a switching target. The LMF 400 may transmit training record confirmation timing instruction information to the UE 100 (step S487). The UE 100 switches to the other trained model in response to receiving the model switching instruction information (step S486), and infers the position information using the other trained model (step S488).

### (2.2) Second Operation Example

Next, a second operation example will be described. The second operation example shows an operation example in which the transmission entity TE is the LMF 400 and the reception entity RE is the UE 100. In the description of the second operation example, differences from the first operation example will mainly be described.

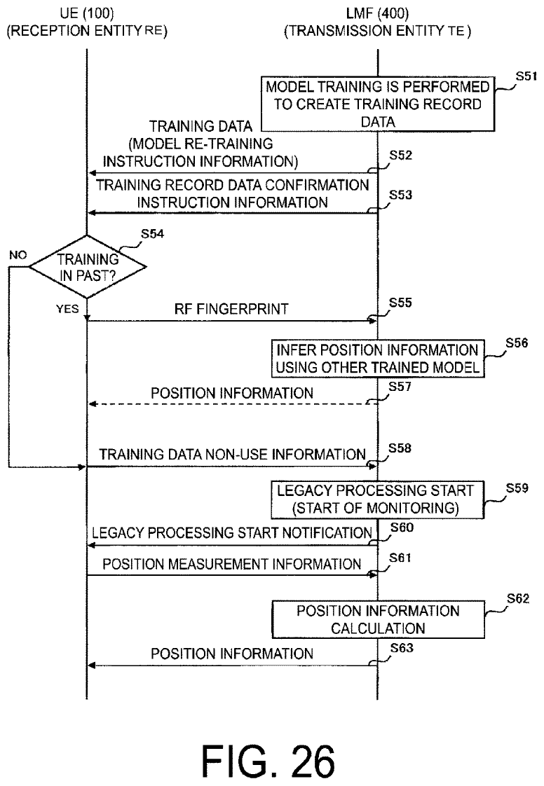

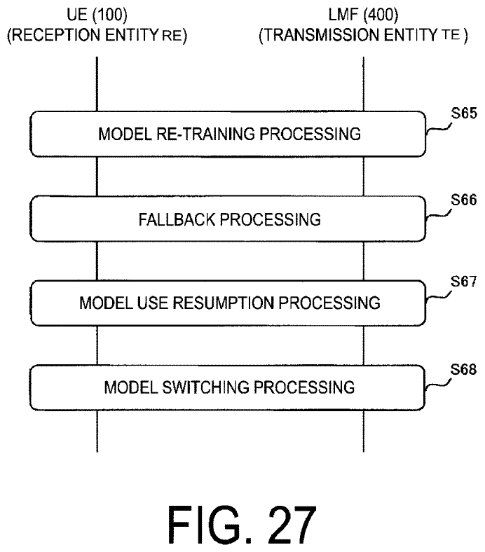

FIGS. 26 and 27 are diagrams showing the second operation example according to the first embodiment. In FIGS. 26 and 27, the use case of “positioning accuracy improvement” is also shown, and the RF fingerprints (input data) and the position information (ground truth data) are used as the training data.

As illustrated in FIG. 26, in step S51, the LMF 400 performs model training using training data and derives the trained model. Also, the LMF 400 creates training record data from the training data. The training record data may include the identification information (for example, a model ID) of the AI/ML model for which the training data has been used.

In step S52, the LMF 400 transmits the training record data to the UE 100. The LMF 400 may transmit, to the UE 100, model re-training instruction information together with the training record data. Alternatively, the LMF 400 may transmit, to the UE 100, information for instructing to transmit the RF fingerprint when it is determined that input data has not been used for model training of the trained model (hereinafter, sometimes referred to as “RF fingerprint transmission instruction information”). The UE 100 receives at least the training record data.

In step S53, the LMF 400 transmits the training record data confirmation instruction information to the UE 100. The UE 100 receives the training record data confirmation instruction information.

In step S54, the UE 100 determines, based on the training record data, whether (currently) acquired input data has been used for (past) model training. Specifically, the UE 100 may perform the determination based on whether the acquired input data (the RF fingerprint) is included in the training record data. When the UE 100 determines that the acquired input data has been used for model training (YES in step S54), the processing proceeds to step S55. On the other hand, when the UE 100 determines that the input data has not been used for model training (NO in step S54), the processing proceeds to step S58.

In step S55, the UE 100 acquires the RF fingerprint and transmits the RF fingerprint to the LMF 400. When the UE 100 confirms that the acquired RF fingerprint has been used for past model training, that is, that the UE 100 is located at a location at which model training has been performed in the past, the UE 100 transmits the acquired RF fingerprint to the LMF 400 so that the RF fingerprint is used as inference data. The UE 100 may transmit, to the LMF 400, the identification information of the AI/ML model included in the training record data together with the RF fingerprint. The LMF 400 receives the RF fingerprint.

In step S56, the LMF 400 infers the position information (inference result data) from the RF fingerprint (inference data) using the trained model.

In step S57, the LMF 400 may transmit the position information to the UE 100.

In step S58, the UE 100 transmits training data non-use information to the LMF 400.

In step S59, the LMF 400 determines to start the monitoring of the trained model in response to receiving the training data non-use information. Also in the second operation example, when the UE 100 determines, based on the training record data, that the current location is the location at which model training has not been performed (NO in step S54), the LMF 400 determines to start monitoring (that is, to start the legacy processing) using reception of the training data non-use information as a trigger.

In step S60, the LMF 400 transmits a legacy processing start notification to the UE 100 and the gNB 200. The LMF 400 may transmit, to the UE 100, model re-training instruction information together with the legacy processing start notification. Alternatively, the LMF 400 may transmit, to the UE 100, the RF fingerprint transmission instruction information together with the legacy processing start notification. The UE 100 and the gNB 200 receive at least the legacy processing start notification. The LMF 400 transmits the PRS transmission request to the gNB 200, and the gNB 200 transmits PRS to the UE 100 in response to receiving the PRS transmission request.

In step 561, the UE 100 creates the position measurement information using the PRS, and transmits the position measurement information to the LMF 400. the LMF 400 receives the position measurement information.

In step S62, the LMF 400 calculates the position information based on the position measurement information.

In step S63, the LMF 400 transmits the calculated position information to the UE 100.

In step S65 (FIG. 27), the UE 100 and the LMF 400 perform model re-training processing.

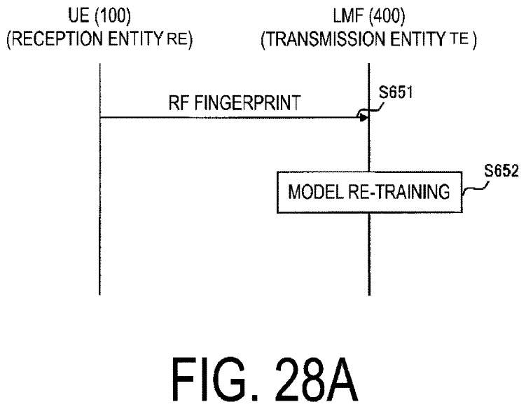

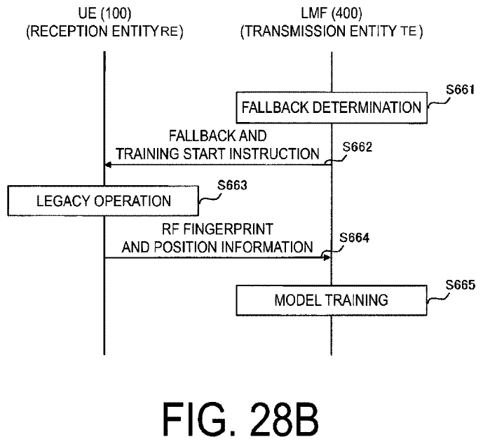

FIG. 28A is a diagram showing an operation example of the model re-training processing according to the first embodiment. As shown in FIG. 28A, the UE 100 transmits the RF fingerprint to the LMF 400 (step S651). The UE 100 may transmit the RF fingerprint in accordance with the RF fingerprint transmission instruction information of step S60. The LMF 400 performs re-training of the trained model (step S51) using the received RF fingerprint as the training data (step S652). The LMF 400 updates the training record data using the training data used for the re-training. Further, the LMF 400 may perform inference using the RF fingerprint acquired in step S651, compare a result obtained through the inference with the position information (ground truth data) obtained in step S62, and omit re-training of the trained model when an error thereof is smaller than a predetermined error (step S652).

Returning to FIG. 27, in step S66, the UE 100 and the LMF 400 perform fallback processing.

FIG. 28B is a diagram showing an operation example of the fallback processing according to the first embodiment. As shown in FIG. 28B, in step S661, the LMF 400 performs a fallback determination. The LMF 400 performs the fallback determination based on the training record data updated by re-training. Specifically, the LMF 400 may determine to perform the fallback when at least any of the following is detected based on the training record data.
(D1) There is no cell ID of a serving cell (for example, the training record data includes no cell ID at all)

(D2) There is no currently used frequency (for example, no currently used frequency is included at all in the training record data).

In step S662, when the LMF 400 determines to perform the fallback, the LMF 400 transmits the fallback instruction information to the UE 100, and also transmits the training start instruction information for instructing to start model training during fallback to the UE 100. The training start instruction information may be information for notifying the UE 100 that the model training is performed during fallback in the LMF 400.

In step S663, the UE 100 performs the legacy operation in accordance with the fallback instruction information. As the legacy operation, for example, the following processing is performed. That is, the LMF 400 instructs the gNB 200 to transmit the PRS, and the gNB 200 transmits the PRS to UE in accordance with the instruction. The UE 100 acquires the position measurement information based on the PRS, and transmits the position measurement information to the LMF 400. The UE 100 acquires the position information from the LMF 400. The UE 100 acquires the RF fingerprint during the legacy operation.

In step S664, the UE 100 transmits, to the LMF 400, the RF fingerprint and the position information acquired during the legacy operation.

In step S665, the LMF 400 performs model training using the RF fingerprint (input data) and the position information (ground truth data) as the training data. As in the first operation example, since the UE 100 is at the location at which the inference has not been performed in the past, the LMF 400 performs the model training using the training data acquired at the location, and derives the trained model.

Returning to FIG. 27, in step S67, the UE 100 and the LMF 400 perform the model use resumption processing.

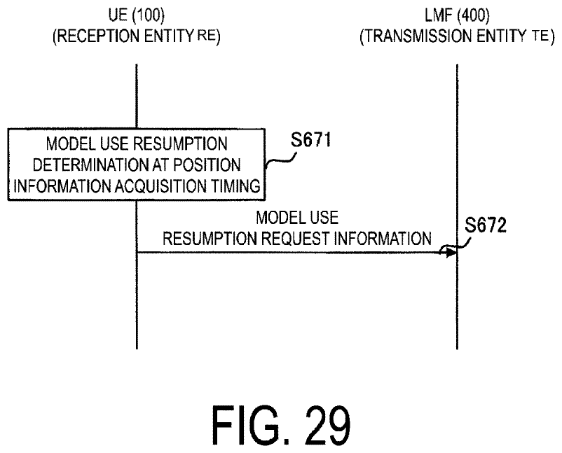

FIG. 29 is a diagram showing an operation example of the model use resumption processing according to the first embodiment. As shown in FIG. 29, in step S671, the UE 100 performs a model use resumption determination based on the training record data at any position information acquisition timing. Specifically, the UE 100 determines to perform the resumption of the use of the trained model derived by the model training performed during the fallback (step S665 in FIG. 28A) when at least any of the following can be confirmed based on the training record data.
(E1) Cell ID of Serving Cell
(E2) Currently Used Frequency
   In step S672, when the UE 100 determines the resumption of use of the trained model, the UE 100 transmits the model use resumption request information to the LMF 400. The model use resumption request information may include a model ID of a resumption target. In the LMF 400, the use of the trained model is resumed in response to receiving the model use resumption request information.

Returning to FIG. 27, in step S68, the UE 100 and the LMF 400 perform the model switching processing. Specifically, as in the first operation example, since the LMF 400 acquires the position information of the UE 100, the LMF 400 may select another trained model optimal for the UE 100 based on the position information and perform model switching to the other trained model. In this case, the LMF 400 transmits, to the UE 100, training record data used when deriving the other trained model. Thus, the UE 100 can perform processing from step S54 and subsequent steps on the other trained model.

### Other Operation Example 1 According to First Embodiment

In the first embodiment, an example has been described in which the LMF 400 is the reception entity RE (first operation example) or the LMF 400 is the transmission entity TE (the second operation example), but the gNB 200 may be used instead of the LMF 400. In this case, the first operation example and the second operation example can be implemented by replacing the LMF 400 with the gNB 200. Between the UE 100 and the gNB 200, various types of data and the like are transmitted using control data or U-plane data instead of the LPP message in the first embodiment.

### Other Operation Example 2 According to First Embodiment

In the first embodiment, a use case of AI/ML technology has been described using “positioning accuracy improvement” as an example, but the present disclosure is not limited thereto. The first embodiment can also be applied to “CSI feedback enhancement” and can also be applied to “beam management.” When “CSI feedback” is applied, a cell ID and/or a frequency used for transmission of CSI-RS may be included together with CSI-RS, as training record data. That is, CSI-RS, the cell ID, and the frequency may be input data (in the training data). CSI-RS and the cell ID may be the input data. CSI-RS and the frequency may be the input data. By including not only CSI-RS but also the cell ID and/or the frequency in the input data, the UE 100 can determine, based on the training record data, whether the training data has been used in the past (that is, whether the UE 100 is at a location at which model training has not been performed in the past) (step S35 in FIG. 20 and step S54 in FIG. 26). Further, when “beam management” is applied, implementation is similarly possible by including, as input data, the cell ID and/or the frequency used for transmission of CSI-RS together with CSI-RS.

### Second Embodiment

Next, a second embodiment will be described. In the second embodiment, differences from the first embodiment will be mainly described. In the first embodiment, an example has been described of starting monitoring based on the training record data. In the second embodiment, an example will be described of starting monitoring based on the inference probability output from the trained model.

Specifically, any of the transmission entity TE or the reception entity RE determines to start monitoring of a trained AI/ML model, based on the inference probability output from the AI/ML model when inferring the inference result data.

Thus, for example, when the inference probability is equal to or less than a monitoring threshold, it is expected that accuracy of the inference result data output from the trained model becomes a problem, and therefore, start of monitoring can be determined when such a state occurs. Accordingly, also in the second embodiment, the mobile communication system 1 can start monitoring at an optimal timing.

In general, in a trained model in which a neural network is used, it is possible to set a sum of probabilities (the probabilities may be referred to as “inference probabilities”) that outputs to 100% by applying a softmax function to a final layer, for example. For example, output A is 30%, output B is 50%, and output C is 20%. In the first embodiment, such inference probabilities obtained from such a neural network are used, for example. Any model may be used as long as inference probabilities for respective outputs are output, and a softmax function need not necessarily used in the final layer.

Hereinafter, an operation example according to the second embodiment will be described. The operation example according to the second embodiment will also be described using the use case of “positioning accuracy improvement”, as in the first embodiment. Also in the second embodiment, the UE 100 is assumed to be in a situation where the UE 100 does not include the GNSS receiver 150 mounted thereon, or even when the UE 100 includes the GNSS receiver 150 mounted thereon, the UE 100 cannot receive a GNSS signal due to being underground or the like. Further, also in the second embodiment, description will be given assuming that the RF fingerprint (input data) and the position information (ground truth data) are used as the training data.

First, an operation example (third operation example) will be described in which the transmission entity TE is the UE 100 and the reception entity RE is the LMF 400. Next, an operation example (fourth operation example) when the transmission entity TE is the LMF 400 and the reception entity RE is the UE 100 will be described.

### (3.1) Third Operation Example

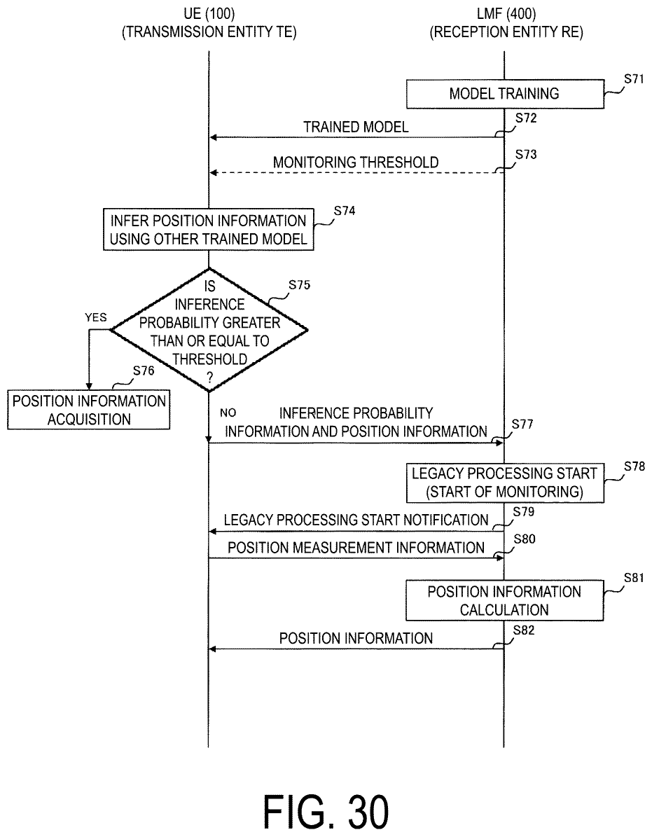

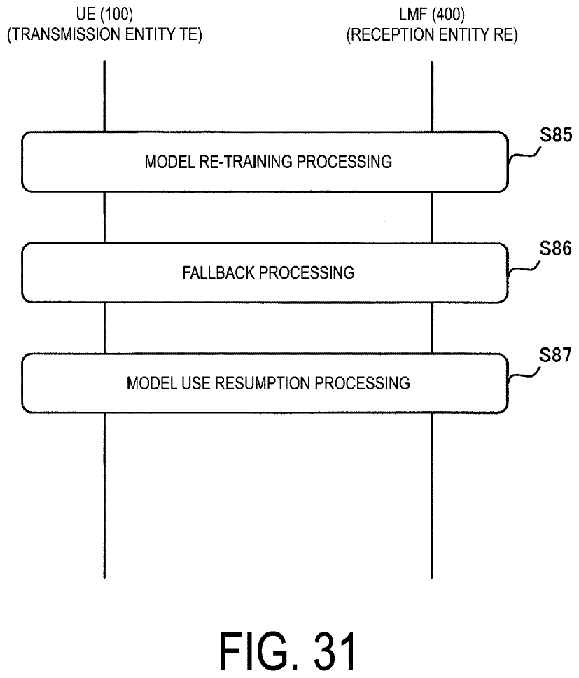

FIG. 30 and FIG. 31 are diagrams showing the third operation example according to the second embodiment. FIG. 30 and FIG. 31, an operation example is shown in which the UE 100 is the transmission entity TE and the LMF 400 is the reception entity RE, as described above. As shown in FIG. 30 and FIG. 31, various types of data and the like are transmitted between the UE 100 and the LMF 400, and also in the second embodiment, all of these are performed using an LPP message. In the following description, the use of the LPP message may be omitted. However, the NRPPa message is used between the LMF 400 and the gNB 200, and a control message or a U-plane message may be used between the gNB 200 and the UE 100.

As shown in FIG. 30, in step S71, the LMF 400 performs model training using training data (the RF fingerprint and the position information) and derives the trained model. The LMF 400 may acquire the training data from the UE 100 in advance.

In step S72, the LMF 400 transmits the trained model to the UE 100. the UE 100 receives the trained model.

In step S73, the LMF 400 may transmit the monitoring threshold to the UE 100. The monitoring threshold is, for example, a threshold used for a determination as to whether to start monitoring. The monitoring threshold may be hard-coded in a specification.

In step S74, the UE 100 infers the position information (inference result data) using the trained model. Further, the UE 100 acquires the inference probability output from the trained model when inferring the position information.

In step S75, the UE 100 determines whether the inference probability is equal to or greater than the monitoring threshold. When the inference probability is equal to or greater than the monitoring threshold (YES in step S75), the processing proceeds to step S76. On the other hand, when the inference probability is less than the monitoring threshold (NO in step S75), the processing proceeds to step S77.

In step S76, the UE 100 determines that the inference result data output from the trained model is used as the position information. In this case, since the inference probability of the inference result data is equal to or greater than the monitoring threshold and accuracy (or reliability) of the inference result data is estimated to be equal to or greater than a certain level, the UE 100 determines that the inference result data is used.

In step S77, the UE 100 transmits information indicating the inference probability (hereinafter, may be referred to as “inference probability information”) and the position information that is inference result data to the LMF 400. When the UE 100 transmits the inference probability information and the position information to the LMF 400, the UE 100 notifies the LMF 400 that the inference probability of the position information is less than the monitoring threshold.

In step S78, the LMF 400 determines to start monitoring of the trained model (that is, to start the legacy processing) in response to receiving the inference probability information and the position information. That is, when the UE 100 determines that the inference probability is equal to or less than the monitoring threshold (NO in step S75), the LMF 400 determines start of monitoring by using, as a trigger, the reception of the inference probability information and the position information.

In step S79, the LMF 400 transmits the legacy processing start notification to the UE 100 and the gNB 200. The UE 100 and the gNB 200 receive the legacy processing start notification. The LMF 400 transmits the PRS transmission request to the gNB 200, and the gNB 200 transmits a PRS to the UE 100 in response to receiving the PRS transmission request.

In step S80, the UE 100 generates the position measurement information based on the PRS, and transmits the position measurement information to the LMF 400. The LMF 400 receives the position measurement information.

In step S81, the LMF 400 calculates the position information of the UE 100 based on the position measurement information.

In step S82, the LMF 400 transmits the position information to the UE 100.

In step S85 (FIG. 31), the UE 100 and the LMF 400 perform model re-training processing.

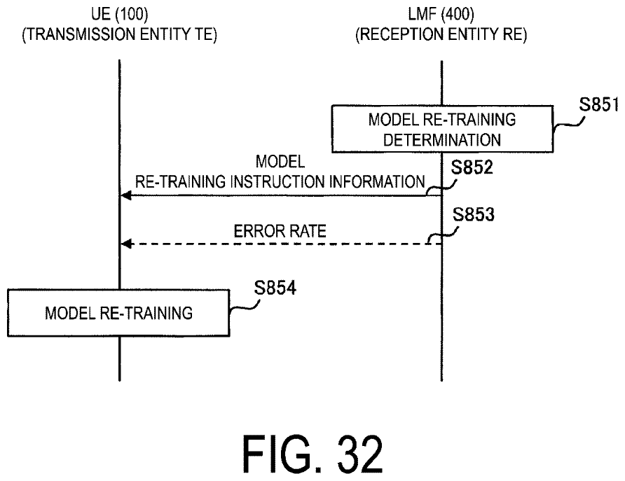

FIG. 32 is a diagram illustrating an operation example of the model re-training processing according to the second embodiment.

As illustrated in FIG. 32, in step S851, the LMF 400 performs a determination as to whether to perform model re-training. Specifically, the LMF 400 determines whether re-training of the trained model is performed based on the position information (step S81) acquired by monitoring (for example, first position information) and the position information acquired from the UE 100 as the inference result data (step S77) (for example, second position information). For example, the LMF 400 may determine that the model re-training is performed when there is an error (or a difference) between the first position information and the second position information, and determine that the model re-training is not performed when the first position information and the second position information are the same. Alternatively, the LMF 400 may determine that the model re-training is performed when the error is equal to or greater than an error threshold, and determine that the model re-training is not performed when the error is less than the error threshold.

In step S852, when the LMF 400 determines that model re-training is performed, the LMF 400 transmits, to the UE 100, model re-training instruction information for instructing to perform the model re-training. The model re-training instruction information may include identification information (for example, a model ID) of the trained model that is a re-training target. The UE 100 receives the model re-training instruction information.

In step S853, in order to enable the UE 100 to determine model re-training, the LMF 400 may transmit, to the UE 100, information representing an error rate used when determining model re-training (hereinafter, may be referred to as “error rate information”). When the UE 100 receives the error rate information, the UE 100 calculates an error (or a difference) between the position information acquired by monitoring (step S82) and the position information acquired as the inference result data. The UE 100 may determine that the model re-training is performed when the error is equal to or greater than the error rate, and may determine that the model re-training is not performed when the error is less than the error rate.

In step S854, the UE 100 performs re-training of the trained model in accordance with the model re-training instruction information. The UE 100 may determine by itself that the model re-training is performed based on the error rate to perform the re-training. When the UE 100 is performing the model re-training, the UE 100 may acquire inference result data (the position information) from inference data (the RF fingerprint) by using the trained model that is a model re-training target as the trained model, and may acquire the inference probability. The UE 100 may transmit the acquired inference probability to the LMF 400.

Returning to FIG. 31, in step S86, the UE 100 and the LMF 400 perform fallback processing.

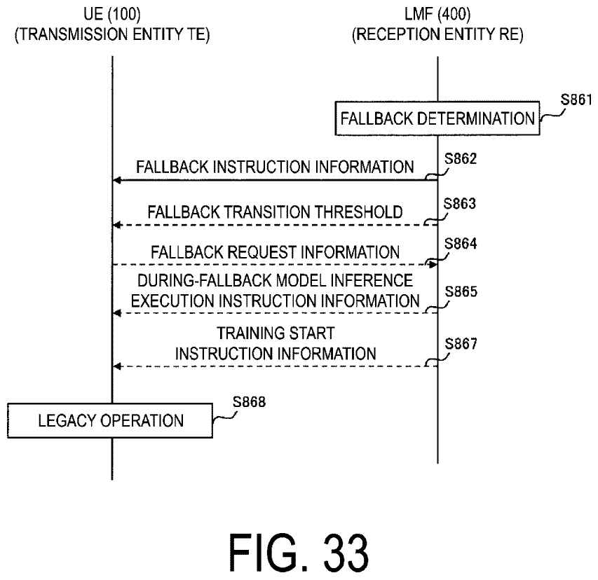

FIG. 33 is a diagram illustrating an operation example of the fallback processing according to the second embodiment. As illustrated in FIG. 33, in step S861, the LMF 400 determines whether to perform fallback, based on the inference probability. Specifically, the LMF 400 may determine to perform fallback when a period in which the inference probability is less than a fallback determination threshold continuously exceeds a fallback determination period. The inference probability may be the inference probability acquired from the UE 100 when model re-training is being performed in the UE 100 (step S854 of FIG. 32).

In step S862, when the LMF 400 determines to perform the fallback, the LMF 400 transmits, to the UE 100, the fallback instruction information indicating that the fallback is performed.

In step S863, the LMF 400 may transmit a fallback transition threshold to the UE 100. This is for enabling the UE 100 to perform the fallback determination. The fallback transition threshold may include the fallback determination threshold and/or the fallback determination period described above. The UE 100 determines whether to perform the fallback, based on the inference probability acquired during model re-training and the fallback transition threshold. The determination itself may be the same as step S861 in the LMF 400. In step S864, when the UE 100 determines to perform the fallback, the UE 100 transmits the fallback request information to the LMF 400. The LMF 400 may transmit the fallback instruction information (step S862) in response to receiving the fallback request information.

In step S865, the LMF 400 may transmit, to the UE 100, information for designating the trained model caused to perform the model inference during execution of the fallback (hereinafter, may be referred to as “during-fallback model inference execution instruction information”). This is for acquiring the inference probability from the designated trained model during execution of the fallback and using it for determination to resume use of a trained model. The during-fallback model inference execution instruction information may include identification information (for example, a model ID) of the trained model that is a target caused to perform the model inference during execution of the fallback. The during-fallback model inference execution instruction information may include an inference result confirmation timing indicating a timing at which an inference result is confirmed. The inference result confirmation timing may be represented by a designated time. The inference result confirmation timing may be represented by a time interval. The inference result confirmation timing may include a threshold relating to the resumption of the use of the trained model. The threshold relating to the resumption of the use may be represented by a probability based on which it can be determined that the resumption of the use may be performed (for example, an inference probability exceeds 70%). Alternatively, the threshold related to the resumption of the use may be represented as a number of consecutive times for which a probability based on which it can be determined that the resumption of the use may be performed is obtained (for example, an inference probability exceeds 70% for ten consecutive times).

In step S867, the LMF 400 may transmit, to the UE 100, the training start instruction information for instructing that model training is performed during execution of the fallback.

In step S868, the UE 100 performs the legacy operation in response to receiving the fallback instruction information. For example, as the legacy operation, an operation according to step S40 to step S44 (FIG. 20) of the first operation example is performed.

Returning to FIG. 31, in step S87, the UE 100 and the LMF 400 perform the model use resumption processing.

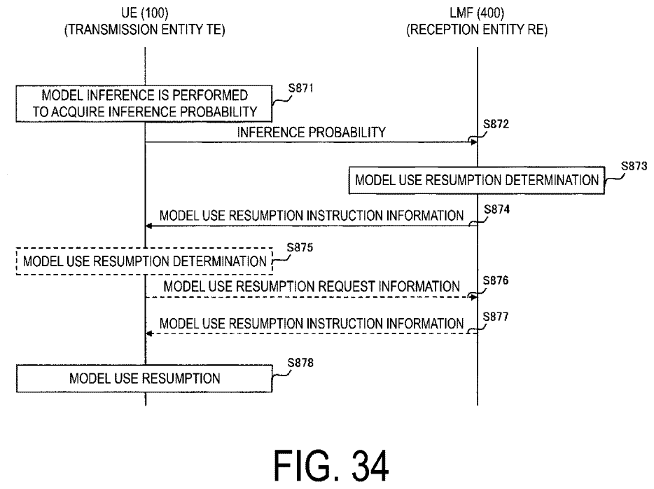

FIG. 34 is a diagram illustrating an operation example of the model use resumption processing according to the second embodiment. When the operation example illustrated in FIG. 34 is started, the UE 100 is assumed to be executing the fallback.

As illustrated in FIG. 34, in step S871, the UE 100 performs model inference and acquires the inference probability. During execution of the fallback, the UE 100 may acquire the inference probability in accordance with the during-fallback model inference execution instruction information (step S865 of FIG. 33). That is, the UE 100 may perform model inference on the trained model designated by the during-fallback model inference execution instruction information, and acquire the inference probability at the inference probability confirmation timing designated by the during-fallback model inference execution instruction information.

In step S872, the UE 100 transmits the acquired inference probability to the LMF 400. The LMF 400 receives the inference probability.

In step S873, the LMF 400 determines the resumption of the use of the trained model based on the inference probability. For example, the LMF 400 may determine that use of the trained model is resumed when the inference probability exceeds a threshold. The LMF 400 may determine that the use of the trained model is resumed when the time of times that the inference probability exceeds the threshold (consecutively) exceeds a predetermined time of times.

In step S874, when the LMF 400 determines that the use of the trained model is resumed, the LMF 400 transmits, to the UE 100, model use resumption instruction information for instructing to resume the use of the model. The model use resumption instruction information may include identification information of the trained model that is a resumption target. Further, the model use resumption instruction information may include an instruction to stop the fallback (or an instruction to stop the legacy operation), together with activation of the trained model. The trained model that is a use resumption target is, for example, the trained model on which model inference has been performed in step S871.

In step S878, the UE 100 resumes the use of the trained model in response to receiving the model use resumption instruction information.

Steps S872 to S874 are an example of performing the determination of use resumption in the LMF 400, but the determination of the use resumption may be performed in the UE 100, as shown in steps S875 to S877.

That is, in step S875, the UE 100 performs a determination of use resumption based on the inference probability acquired in step S871. Specifically, the UE 100 performs the determination based on whether the inference probability exceeds the threshold relating to the resumption of the use of the trained model. The threshold relating to the resumption of the use of the trained model is included in the during-fallback model inference execution instruction information (step S865 of FIG. 33).

In step S876, when the UE 100 determines to perform resumption of the use of the trained model, the UE 100 transmits, to the LMF 400, model use resumption request information indicating a request to resume the use of the trained model. The model use resumption request information includes identification information of the trained model for which the resumption of the use is requested.

In step S877, the LMF 400 transmits the model use resumption instruction information to the UE 100 in response to receiving the model use resumption request information. The UE 100 resumes use of the trained model in response to receiving the model use resumption instruction information (step S878).

### (3.2) Fourth Operation Example

Next, a fourth operation example will be described. The fourth operation example is an operation example when the LMF 400 is the transmission entity TE and the UE 100 is a reception entity. The fourth operation example will be described mainly focusing on differences from the third operation example.

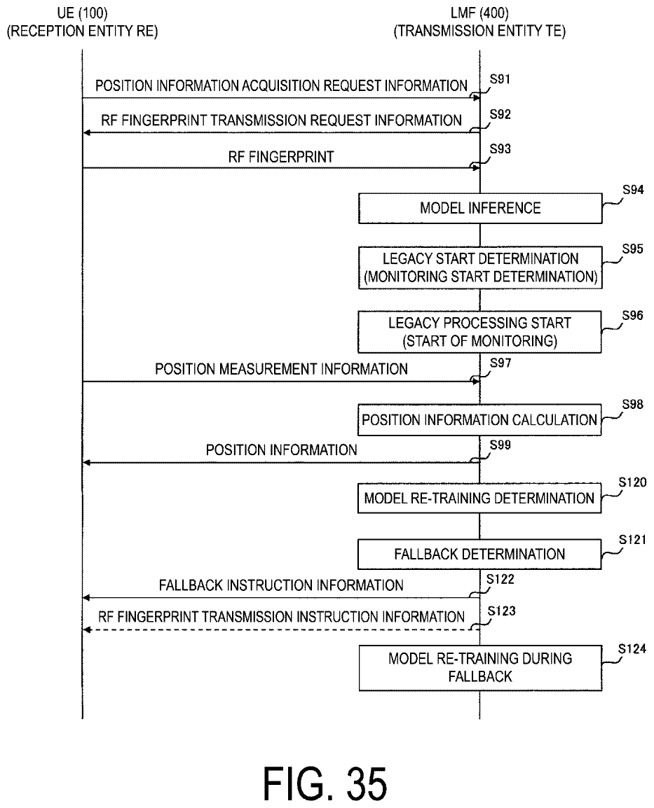

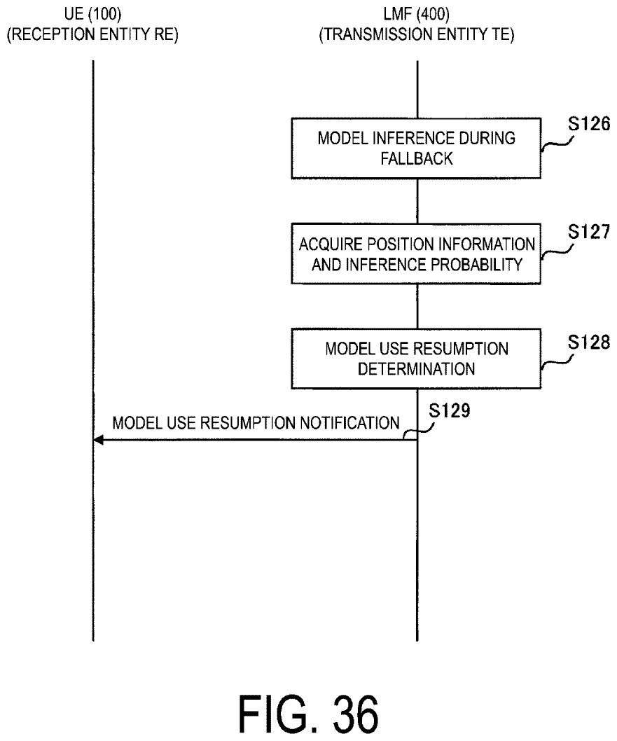

FIGS. 35 and 36 are diagrams showing the fourth operation example according to the second embodiment. The LMF 400 is assumed to hold the trained model.

As illustrated in FIG. 35, in step S91, the UE 100 transmits, to the LMF 400, information indicating a request to acquire the position information using model inference (hereinafter, may be referred to as “position information acquisition request information”).

In step S92, the LMF 400 transmits, to the UE 100, information for requesting to transmit the RF fingerprint (inference data) (hereinafter, “RF fingerprint transmission request information”) in response to receiving the position information acquisition request information.

In step S93, the UE 100 transmits the RF fingerprint to the LMF 400 in response to receiving the RF fingerprint transmission request information.

In step S94, the LMF 400 performs model inference by using the trained model, with the received RF fingerprint as the inference data.

In step S95, the LMF 400 performs a legacy processing start determination (or monitoring start determination). The LMF 400 may perform the legacy processing start determination based on whether the inference probability from the trained model acquired by model inference (step S94) is equal to or greater than the monitoring threshold, similarly to the determination in the third operation example (step S75 of FIG. 30). Hereinafter, description will be given assuming that the LMF 400 has determined to start the legacy processing (that is, the monitoring processing).

In step S96, the LMF 400 starts the legacy processing. Specifically, the LMF 400 transmits the PRS transmission request to the gNB 200, and the gNB 200 transmits the PRS to the UE 100 in response to reception of the PRS transmission request, similarly to the third operation example.

In step S97, the UE 100 creates the position measurement information based on the PRS, and transmits the position measurement information to the LMF 400.

In step S98, the LMF 400 calculates the position information of the UE 100 based on the position measurement information.

In step S99, the LMF 400 transmits the position information to the UE 100.

In step S120, the LMF 400 determines whether to perform the model re-training. The LMF 400 may perform the determination based on whether there is an error by comparing the position information acquired through the legacy operation (step S98) with the position information obtained through the model inference (step S94), similarly to step S851 (FIG. 32) of the third operation example.

In step S121, when the LMF 400 determines that model re-training is performed, the LMF 400 performs fallback determination. The fallback determination may be the same as step S861 (FIG. 33) of the third operation example.

In step S122, when the LMF 400 determines to perform the fallback, the LMF 400 transmits the fallback instruction information for instructing to perform fallback to the UE 100. The UE 100 receives the fallback instruction information. Since the LMF 400 has determined to perform fallback, the LMF 400 executes fallback (that is, performs the legacy operation).

In step S123, the LMF 400 may transmit, to the UE 100, the RF fingerprint transmission instruction information for instructing to transmit the RF fingerprint. In response to receiving the RF fingerprint transmission instruction information, the UE 100 acquires the RF fingerprint and transmits the acquired RF fingerprint to the LMF 400.

In step S124, the LMF 400 may perform re-training of the trained model in preparation for the resumption of the use of the trained model during execution of the fallback.

In step S126 (FIG. 36), the LMF 400 performs model inference by using the trained model (that is, the updated model) obtained by re-training of the trained model during execution of the fallback.

In step S127, the LMF 400 acquires the position information and the inference probability from the updated model through the model inference of step S126.

In step S128, the LMF 400 performs the model use resumption determination. Specifically, the LMF 400 may determine that the use of the model is resumed when the following two conditions are satisfied.
(F1) The inference probability exceeds the monitoring threshold (or the number of times that the inference probability exceeds the monitoring threshold in a certain period is equal to or greater than a predetermined number of times).
(F2) An error between the position information obtained through the legacy operation (step S99 of FIG. 35) and the position information obtained through the model inference (step S127) is equal to or less than an error threshold (or the number of times that the error is equal to or less than the error threshold in a certain period is equal to or greater than a predetermined number of times).

In step S129, when the LMF 400 determines the resumption of the use of the trained model, the LMF 400 transmits a model use resumption notification to the UE 100.

### Other Operation Example 1 According to Second Embodiment

Also in the second embodiment, the gNB 200 may be used instead of the LMF 400, similarly to the first embodiment. In this case, the third operation example and the fourth operation example can be implemented by replacing the LMF 400 with the gNB 200. Between the UE 100 and the gNB 200, various types of data and the like are transmitted using control data or U-plane data instead of the LPP message in the first embodiment.

### Other Operation Example 2 According to Second Embodiment

The second embodiment can also be applied to the “CSI feedback enhancement” and can also be applied to the “beam management,” similarly to the first embodiment. In the “CSI feedback enhancement”, for example, when the transmission entity TE acquirers the inference probability when CSI (inference result data) is obtained from CSI-RS (inference data) by using the trained model, and determines whether to start monitoring based on the inference probability (step S75 of FIG. 30 or step S95 of FIG. 35). Accordingly, even in the “CSI feedback enhancement”, implementation is possible similarly to the second embodiment. Also in the “beam management”, the transmission entity TE acquires the inference probability when obtaining an optimal beam (inference result data) from CSI-RS (inference data) by using the trained model, making it possible to implement similarly to the second embodiment.

### OTHER EMBODIMENTS

In the first embodiment and the second embodiment described above, the supervised learning has mainly been described, while not limited thereto. For example, unsupervised learning or reinforcement learning may be applied to the first and second embodiments.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps need not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network device or a part (CU, DU, or RU) of the base station. The network node may include a combination of at least a part of the apparatus of the core network and at least a part of the base station.

A program (e.g., information processing program) for causing a computer to execute each process or each function according to the above-described embodiment may be provided. A program (e.g., mobile communication program) may be provided that causes the mobile communication system 1 to execute each of the processing operations or each of the functions according to the embodiments described above. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Such a recording medium may be a memory included in the UE 100, the gNB 200, and the LMF 400.

Functions implemented by the UE 100 or the gNB 200 (network node) may be implemented in circuitry or processing circuitry including a general-purpose processor, a special-purpose processor, an integrated circuit, application specific integrated circuits (ASICs), a central processing unit (CPU), a circuit of the related art, and/or a combination thereof, which are programmed to implement the described functions. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure. It is also possible to combine each embodiment, each operation example, each process, and the like without contradicting.

### SUPPLEMENTS

### Supplement 1

A communication control method in a mobile communication system including a transmission entity configured to infer inference result data from inference data by using a trained AI/ML model and a reception entity, the transmission entity being capable of transmitting the inference result data to the reception entity, the communication control method including: determining, by any of the transmission entity or the reception entity, to start monitoring of the trained AI/ML model, based on training record data obtained by compressing training data used when causing the AI/ML model to undergo model training.

### Supplement 2

The communication control method according to Supplement 1, wherein
the determining includes determining to start monitoring the trained AI/ML model when any of the transmission entity or the reception entity determines, based on the training record data, that a current location is a location at which the model training has not been performed, and the training record data includes the RF fingerprint.

### Supplement 3

The communication control method according to supplement 1 or 2, wherein the determining includes the steps of.
determining, by the transmission entity, whether acquired input data has been used for the model training of the AI/ML model, based on the training record data;
transmitting, by the transmission entity to the reception entity, training data non-use information indicating that the input data has not been used for the model training when determining that the input data has not been used for the model training of the AI/ML model; and
determining, by the reception entity, to start monitoring of the trained AI/ML model in response to receiving the training data non-use information.

### Supplement 4

The communication control method according to any one of supplements 1 to 3, further including the steps of:
by the reception entity, deriving the trained AI/ML model by using the training data and transmitting the trained AI/ML model to the reception entity; and
transmitting, by the reception entity, the training record data to the reception entity.

### Supplement 5

The communication control method according to any one of supplements 1 to 4, further including:
determining, by the reception entity, whether to perform re-training of the AI/ML model based on the training record data.

### Supplement 6

The communication control method according to any one of supplements 1 to 5, further including:
determining, by the transmission entity, whether to perform fallback of the AI/ML model, based on the training record data updated by the re-training.

### Supplement 7

The communication control method according to any one of supplements 1 to 6, further including:
determining, by the transmission entity, resumption of use of an AI/ML model derived by model training performed during the fallback based on the training record data.

### Supplement 8

The communication control method according to any one of supplements 1 to 7, wherein
the transmission entity is a user equipment and the reception entity is a network apparatus.

### Supplement 9

A communication control method in a mobile communication system including a transmission entity configured to infer inference result data from inference data by using a trained AI/ML model and a reception entity, the transmission entity being capable of transmitting the inference result data to the reception entity, the communication control method including:
determining, by the transmission entity, to start monitoring of the trained AI/ML model, based on an inference probability output from the AI/ML model when the inference result data is inferred.

### Supplement 10

The communication control method according to any one of supplements 1 to 9, further including:
determining, by the reception entity, whether to cause re-training of the AI/ML model, based on first position information acquired from the transmission entity by the monitoring and second position information acquired from the transmission entity as the inference result data.

### Supplement 11

The communication control method according to any one of supplements 1 to 10, further including:
determining, by the reception entity, whether to perform fallback of the AI/MWL model, based on the inference probability.

### Supplement 12

The communication control method according to any one of supplements 1 to 11, further including the steps of:
by the transmission entity, acquiring the inference probability by using the trained AI/ML model during execution of the fallback and transmitting the inference probability to the reception entity; and
determining, by the reception entity, resumption of use of the trained AI/MWL model, based on the inference probability.

### Supplement 13

The communication control method according to any one of supplements 1 to 12, wherein the transmission entity is a user equipment and the reception entity is a network apparatus.

### REFERENCE SIGNS

1: Mobile communication system
20: 5GC (CN)
100: UE
110: Receiver
120: Transmitter
130: Controller
200: gNB
210: Transmitter
220: Receiver
230: Controller
400: LMF
410: Receiver
420: Transmitter
430: Controller
A1: Data collector
A2: Model trainer
A3: Model inferrer
A4: Data processor
A5: Model manager
A6: Model recorder
TE: Transmission entity
RE: Reception entity

1. A communication control method in a mobile communication system including a user equipment configured to infer inference result data from inference data by using a trained artificial intelligence (AI)/machine learning (ML) model and a network apparatus, the user equipment being capable of transmitting the inference result data to the network apparatus, the communication control method comprising:
receiving, by the user equipment, configuration information from the network apparatus;
performing, by the user equipment, inference of the AI/ML model in accordance with the configuration information; and
transmitting, by the user equipment, information relating to a prediction accuracy of the inference result data, together with the inference result data, to the network apparatus.

2. A user equipment in a mobile communication system including the user equipment configured to infer inference result data from inference data by using a trained AI/ML model and a network apparatus, the user equipment being capable of transmitting the inference result data to the network apparatus, the user equipment comprising a transceiver circuitry and a processing circuitry operatively associated with the transceiver circuitry and configured to execute processing of:
receiving configuration information from the network apparatus;
performing inference of the AI/ML model in accordance with the configuration information; and
transmitting information relating to a prediction accuracy of the inference result data, together with the inference result data, to the network apparatus.

3. A mobile communication system comprising:
a user equipment configured to infer inference result data from inference data by using a trained AI/ML model; and
a network apparatus, wherein
the user equipment is configured to be capable of transmitting the inference result data to the network apparatus,
the user equipment is configured to receive configuration information from the network apparatus,
the user equipment is configured to perform inference of the AI/ML model in accordance with the configuration information; and
the user equipment is configured to transmit information relating to a prediction accuracy of the inference result data, together with the inference result data, to the network apparatus.

4. A non-transitory computer-readable storage medium storing instructions that, when executed by a processor of a user equipment in a mobile communication system including the user equipment configured to infer inference result data from inference data by using a trained AI/ML model and a network apparatus, the user equipment being capable of transmitting the inference result data to the network apparatus, cause the processor to perform the method according to claim 1.

5. A chipset for a user equipment in a mobile communication system including the user equipment configured to infer inference result data from inference data by using a trained AI/ML model and a network apparatus, the user equipment being capable of transmitting the inference result data to the network apparatus, the chipset configured to execute the instructions stored on the non-transitory computer-readable medium of claim 4.
